(19) United States
(12) Patent Application Publication
(10) Pub. No.: US 2024/0328572 A1
(43) Pub. Date: Oct. 3, 2024

(54) BUILDING ENVELOPE ACCESS SYSTEM

(71) Applicant: DEFY-HI ROBOTICS PTY LTD, Lindfield (AU)

(72) Inventors: Oliver NICHOLLS, Lindfield (AU); Thomas Alexander BANNERMAN, Lindfield (AU); Abigail Grace WIDIN, Lindfield (AU); Lorenzo GONZALEZ, Lindfield (AU); Luke BOUTTELL, Lindfield (AU); Nicolas GIOVANANGELI, Lindfield (AU); Bartholomew Jeremy CAFFIN, Lindfield (AU)

(21) Appl. No.: 18/438,869

(22) Filed: Feb. 12, 2024

Related U.S. Application Data
(63) Continuation-in-part of application No. PCT/AU2022/050861, filed on Aug. 9, 2022.

(30) Foreign Application Priority Data
Aug. 10, 2021 (AU) 2021902482

(51) Int. Cl. F16M 11/42; F16M 11/04; F16M 13/02; G01M 5/00; G03B 17/56

(52) U.S. Cl. CPC F16M 11/425; F16M 11/046; F16M 13/022; G01M 5/0075; G03B 17/561; F16M 2200/08

(57) ABSTRACT

System 1 for positioning a functional platform 5 at an elevated position relative to external walls of a building 2, such as to allow surveying or maintaining the building 2. The system 1 includes an elongate, flexible element 10, a carriage 4 mountable to the flexible element 10 and operable to move along the flexible element 10, the carriage 4 configured to suspend the functional platform 5 operatively below the carriage 4, and a pair of support assemblies 6. Each support assembly 6 includes a mount 14 configured to be fixed to the building 2 to define a position axis 7, and an elongate support member 13 configured to connect to the mount 14 to be rotatable about the position axis, the support member 13 defining a free end 11 configured to support the flexible element 10. The system 1 also includes a retraction mechanism engageable with the flexible element 10 and operable to retract and tension the flexible element 10 between the support members 13.

### CROSS REFERENCE TO RELATED APPLICATIONS

This application is a continuation-in-part under Section 111 of PCT Application No. PCT/AU2022/050861, filed Aug. 9, 2022, which claims priority from Australian Patent Application No. 2021902482, filed on Aug. 10, 2021, the entirety of which is hereby incorporated by reference herein. This application maintains co-pendency with PCT/AU2022/050861 because the 30 month anniversary of the Aug. 10, 2021 priority date fell on a Saturday (35 USC Section 21).

### TECHNICAL FIELD

The present disclosure generally relates to systems for enabling access to the external envelope of a building, and particularly relates to systems operable to access the external envelope of a building to conduct maintenance or surveying of the external surfaces of the building, for example, cleaning the façade or windows.

### BACKGROUND

Routine maintenance of a building typically involves regular monitoring and cleaning of the external surfaces of the building, such as the façade and windows. Access to the building envelope is required for façade inspection, such as to identify cracks or other damage, as well as window cleaning, and the like. For the first few floors of a building, it may be possible to manually perform maintenance using elevated work platforms and/or using brushes mounted on extendable poles. However, depending on the height of the building and its location such methods may not be suitable. For higher levels of tall buildings, for example above the third floor, such methods have insufficient reach.

To maintain the higher levels of a building, the building envelope is generally accessed by a person from the top of the building, for example, by way of a building maintenance unit (BMU), a suspended scaffold, or by rappelling (abseiling).

A conventional building maintenance unit (BMU) includes a permanently installed mechanism, typically being a crane or boom arm statically mounted to the top of a building, or movably mounted to the building, such as on rails. The mechanism is used to lower a working platform adjacent to external walls of the building. One or more persons stand on the platform to allow manual inspection and maintenance of the building. Typical BMUs are expensive, require permanent attachment to an individual building, and operation is often restricted to specific authorised persons. Furthermore, conducting manual work on a BMU presents a safety risk to the worker.

Besides full-sized BMUs, alternative platforms may be lowered, or scaffolds suspended, from a wheeled davit or crane arranged at a top of a building. Whilst these structures can be portable about the top of the building, they are typically large, unwieldy, and not practical for transporting between buildings. These mechanisms are usually also expensive and are not suitable for all buildings. Also, where a building includes obstacles on the roof, for example, ducts and air conditioning, this can significantly impede access.

The above traditional means of accessing the building envelope at heights requires workers to use the BMU, perform rope access, or use some other elevated work platform (EWP), all of which can present a human safety risk. Additionally, these methods of accessing the building envelope can be compromised by inclement weather, as well as being costly in human labour and mechanical hire, installation and/or maintenance.

Some past approaches have involved using an unmanned aerial vehicle (UAV, typically referred to as a drone, to attempt to automate building envelope maintenance. However, UAVs are often not suitable at locations where such aircraft are illegal or pose safety risks. Attempts to overcome this limitation, have included suspending UAVs from ropes or rope systems mounted directly to the building, for example, by a winch at each corner of the building, to guide motion of the UAV relative to the building. In such configurations, the UAV is typically unable to access the extents of the building face, particularly the top edge and lower corners, due to having a limited range of motion defined by the attached ropes. Also, motion of the UAV can be obstructed by structures projecting from the building face, for example, mullions or projecting façade panels, which can result in inefficient and/or incomplete maintenance.

Any discussion of documents, acts, materials, devices, articles or the like which has been included in the present specification is not to be taken as an admission that any or all of these matters were common general knowledge in the field relevant to the present disclosure as it existed before the priority date of each of the appended claims

### SUMMARY

According to some disclosed aspects, there is provided a system for positioning a functional platform at an elevated position relative to external walls of a building. The system includes: an elongate, flexible element; a carriage mountable to the flexible element and operable to move along the flexible element, the carriage configured to suspend the functional platform operatively below the carriage; a pair of support assemblies, each support assembly including: a mount configured to be fixed to the building to define a position axis; and an elongate support member configured to connect to the mount to be rotatable about the position axis, the support member defining a free end configured to support the flexible element; and a retraction mechanism engageable with the flexible element and operable to retract the flexible element, whereby mounting the support assemblies at a top of a building to be spaced apart, and securing the flexible element between a fixed position, against the free end of each support member, and to the retraction mechanism, and operating the retraction mechanism, causes the flexible element to tension between the support members to allow arranging the flexible element above the top of the building, and allow mounting the carriage, carrying the functional platform, on the flexible element.

Each support member may be mountable to one of the mounts so that, in use, the support members are arrangeable to diverge away from each other.

Each support assembly may define a tension axis arranged to be orthogonal to the position axis, and each support member be configured to connect to mount to be rotatable about the position axis and the tension axis so that pivoting each support arm about the associated tension axis, in use, allows moving the free ends of the support arms apart so that the support members diverge away from each other.

Each mount may be configured to be mounted to a planar surface of the building to arrange the position axis to be parallel to the planar surface, and each support assembly further include a coupling configured to be rotatably mounted about the position axis to connect the support member to the mount, the coupling defining the tension axis and the support member being rotatably mountable about the tension axis.

Each support assembly may include a restriction member configured to be arranged, in use, to inhibit movement of the free ends of the support members towards each other. The restriction member may include a first brace configured to be secured between the support member and the building to limit rotation of the support member about the tension axis. The first brace may be configured as a flexible line configured to be secured between the second end of the support member and the building.

Each support assembly may include an adjustment member configured to be arranged, in use, between the support member and the building, each adjustment member being length adjustable to allow adjusting an extent of rotation of the support member about the position axis. Additionally, each support assembly may include a strut arranged to extend away from the support member, and the adjustment member be securable between the strut and a fixed position. The strut may be rotatable mounted about a third axis defined by the support member. Each support assembly may also include a second brace securable between the strut and the free end of the support member. Each adjustment member may comprise a further flexible element, and the system include at least one adjustment mechanism operable to adjust the effective length of at least one of the further flexible elements.

According to other disclosed embodiments, there is provided a system for positioning a functional platform at an elevated position relative to an external wall of a building, the system including: an elongate, flexible element; a carriage mountable to the flexible element and operable to move along the flexible element, the carriage configured to suspend the functional platform operatively below the carriage; a support assembly having a mount configured to be fixed to the building to define a position axis, and an elongate support member configured to connect to the mount to be rotatable about the position axis, the support member defining a free end arranged to support the flexible element; and a retraction mechanism engageable with the flexible element and operable to retract the flexible element, whereby mounting the support assembly at a top of a building, and securing the flexible element between a fixed position, across the free end of the support member, and to the retraction mechanism, and operating the winding mechanism, causes the flexible element to tension between the fixed position and the support member to allow arranging the flexible element above the top of the building, and allow mounting the carriage, carrying the functional platform, on the flexible element.

The carriage may include a winding mechanism operable to operatively raise or lower the functional platform. The carriage may include a drive mechanism to drive the carriage along the flexible element. The carriage may include a displacement mechanism operable, in use, to displace the functional platform towards or away from the flexible element.

The system as described in any of the preceding paragraphs may include the functional platform which is configured to conduct one or more of: generate a digital map of at least a portion of the geometry of the building; capture one or more images of the building; measure one or more physical parameters of the building; clean at least a portion of the building; repair the building; install one or more objects on the building.

The functional platform may include a utility module arranged at one side of the platform, and a drive mechanism operable to drive the platform in at least one direction to allow urging the utility module towards, or against, the building. The drive mechanism may include at least one propulsion mechanism arranged at an opposite side of the platform to the utility module. The platform may include a plurality of the propulsion mechanisms, and each mechanism include a powered rotor operable to generate thrust.

The utility module may include at least one of a cleaning apparatus and an imaging system. The cleaning apparatus may include at least one powered rotatable brush. The cleaning apparatus may include a suction mechanism having an intake head arranged adjacent the at least one brush, the suction mechanism operable to draw the utility module towards the building. The cleaning apparatus may include a camera and light source mounted within the intake head.

The utility module may be releasably mounted to the platform to allow interchanging the utility module with an alternative utility module. The utility module may be rotatably mounted to the platform about at least one axis. The utility module may be associated with a positioning mechanism operable to orientate at least a portion of the utility module relative to the platform.

According to further aspects of the disclosure, there is provided a functional platform for suspending from a line to be at an elevated position relative to a building, the functional platform including: a body including a connector arranged at an operatively top end of the body and configured to couple to the line; a utility module arranged at one side of the body; and a drive mechanism operable to drive the platform in at least one direction to allow driving the utility module relative to the building.

The drive mechanism may include at least one propulsion mechanism arranged at an opposite side of the body to the utility module. The platform may include a plurality of the propulsion mechanisms, and each mechanism includes a powered rotor operable to generate thrust. Each propulsion mechanism may be arranged in a conduit defined by the body to provide ducted thrust. At least two of the propulsions mechanisms may be arranged opposite to each other in a first direction to generate thrust in an operative forwards direction and rearwards direction, and at least two of the propulsions mechanisms are arranged opposite to each other in a second direction being orthogonal to the first direction to generate thrust in operative sideways directions.

The utility module may be mounted to a displacement mechanism operable to displace the utility module towards or away from the body. The displacement mechanism may include a counterweight arranged to move in an opposite direction to the utility module relative to the body. The utility module may be rotatably mounted to the displacement mechanism about at least one axis to allow tilting the utility module relative to the displacement mechanism. The utility module may be associated with a positioning mechanism operable to orientate at least a portion of the utility module relative to the platform. The utility module may be releasably mounted to the platform to allow interchanging the utility module with an alternative utility module.

The utility module may include at least one of a tool and a sensor. The utility module may include at least one of a cleaning apparatus, a window seal integrity system, and an imaging system. The cleaning apparatus may include at least one powered rotatable brush. The cleaning apparatus may include a suction mechanism having an intake head arranged adjacent the at least one brush, the suction mechanism operable to draw the utility module towards the building. The cleaning apparatus may include a camera and light source mounted within the intake head.

According to other aspects of the disclosure, there is provided a carriage for positioning a load, the carriage including: a chassis; at least one support assembly secured to the chassis and configured to mount the carriage to a support element; and a pair of motion control mechanisms secured to the chassis, each motion control mechanism including a spool, an elongate flexible drive line fixed to the spool, and drive means operable to rotate the spool to wind or unwind the drive line about the spool, where the motion control mechanisms are configured such that operating the first motion control mechanism to wind the associated drive line about the spool causes concurrent operation of the second motion control mechanism to unwind the drive line from the spool.

A system may be provided including a support element configured to be mounted between fixed positions to be operatively horizontal and the carriage as described in the previous paragraph and including at least one load line connected to the chassis and configured to be secured to the load to allow suspending the load operatively below the carriage, whereby mounting the at least one support assembly to the support element, securing a free end of each drive line to a fixed position, and operating the motion control mechanisms causes the carriage to move laterally along the support element.

According to a further aspect of the disclosure, there is provided a carriage for positioning a load, the carriage including: a chassis; at least one support assembly secured to the chassis and configured to mount the carriage to a support element; and a lateral motion control mechanism secured to the chassis, the lateral motion control mechanism including a first spool, an elongate flexible first drive line fixed to the first spool, and drive means operable to rotate the first spool to wind or unwind the first drive line about the first spool; a vertical motion control mechanism secured to the chassis, the vertical motion control mechanism including a second spool, an elongate flexible second drive line fixed to the second spool, and drive means operable to rotate the second spool to wind or unwind the second drive line about the second spool, where the first drive line defines a free end configured to be secured to a fixed position, and the second drive line defines a free end configured to be secured to a load to allow suspending the load operatively below the carriage, and the carriage further includes a utility line arranged to extend along each of the first drive line and the second drive line, and between the first spool and the second spool, to allow securing the utility line between the fixed position and the load.

The utility line may be configured to convey one of fluid and electrical power to the load.

The carriage may include a pair of the lateral control mechanisms, a pair of the vertical control mechanisms, and a pair of the utility lines, and one of the utility lines be configured to convey fluid to the load, and the other utility line is configured to convey electrical power to the load.

Each of the first drive line and the second drive line may be hollow, and the utility line be arranged to extend within each of the first drive line and the second drive line.

According to other disclosed embodiments, there is provided a system for positioning a functional platform including an imaging system at an elevated position relative to external walls of a building to facilitate façade inspection, the system including: a manually portable trolley configured to be movable across a roof of the building, and carrying a crane member having a distal end, the trolley and crane member configured to be disassembled; a winch mechanism mounted to the trolley; and a suspension line extending between the functional platform and the winch mechanism. In use, the trolley is positioned on the roof of the building so that the distal end is arranged beyond a leading edge of the building to suspend the functional platform at the elevated position, and is movable across the roof, and the functional platform is raised and lowered via the suspension line to allow access across the building façade.

The trolley may be configured to utilize the rails of a building management unit (BMU) to manoeuvre about the roof of the building.

The trolley may carry a pair of spaced rail engagement mechanisms configured to releasably engage parallel rails of the BMU.

At least one of the rail engagement mechanisms may be slidably mounted to the trolley to allow selectively adjusting spacing of the pair of rail engagement mechanisms.

The trolley may include three of the rail engagement mechanisms arranged on a common plane at vertices of a notional triangle.

Each rail engagement mechanism may include a bogie frame carrying a plurality of wheels.

The bogie frame may be configured to arrange a pair of wheels at one side of a rail, and at least one other wheel on an opposed side of the rail.

Each rail engagement mechanism may be pivotably mounted to the trolley to allow motion of the trolley along curved rails.

The trolley may include a plurality of wheels to allow wheeling about the roof of the building.

The trolley may include a plurality of castor wheels arranged on a common plane at vertices of a notional triangle.

The crane member may be rotatably mounted to the trolley.

The crane member may be rotatable about an operatively horizontal axis to allow tilting the distal end relative to the trolley.

The crane member may be rotatably mounted to the trolley about an operatively vertical axis to allow lateral rotation of the distal end relative to the trolley.

The crane member may include a jib defining the distal end, a counterjib extending in an opposite direction to the jib, a jib strut extending substantially perpendicular to the jib. The system may also include one or more tension members connected between the jib, the jib strut, and the counterjib. The system may also include a further tension member connected between the counterjib and the trolley. The system may include one or more counterweights mounted to the counterjib.

A counterweight system may be associated with the trolley.

The crane member may be modular to allow being stowed in a compact volume.

The crane member may be formed from a plurality of releasably connected struts.

The jib may be formed from a plurality of releasably connected tubular members.

According to further disclosed aspects, there is provided a manually portable modular kit for facilitating façade inspection of a building, the kit including: a trolley comprising a base module configured for movement across a roof of a building, and a releasably mountable jib module; an imaging module associated with one or more drive or propulsion mechanisms operable to stabilise the module relative to the building; a cable connectable to the imaging module; and a winch module releasably mountable on the trolley and having a spool, the winch module engageable with the cable and operable to wind the cable around the spool.

The modular kit may include a plurality of motion control modules releasably mountable to the base module, where each motion control module is operable to facilitate movement of the trolley across the roof.

Each motion control module may be configured for releasably mounting to a rail of a BMU.

The modular kit may include a drive mechanism configured to be associated with one of the motion control modules and be operable to drive the motion control module along the rail.

The modular kit may include a controller module communicatively coupled with the winch module, the imaging module, and the drive mechanism and operable to control operation of any of the winch module, the imaging module, and the drive mechanism.

The modular kit may include a pivot module arrangeable between the base module and the jib module to allow relative rotation of the base module and the jib module about at least one axis.

At least one of the base module and the jib module may be formed from a plurality of interconnectable elongate members.

According to further disclosed aspects, there is provided a method for inspecting a façade of a building using the modular kit as described in any of the preceding paragraphs, the method including: mounting the jib module to the base module; mounting the winch module to the trolley; securing the cable between the imaging module and the winch module; positioning the trolley on a roof of the building so that an end of the jib module is spaced outwardly from the building to suspend the imaging module in an elevated position adjacent the building; and operating the winch module to raise or lower the imaging module, and/or moving the trolley along one or more paths about a peripheral region of the roof, concurrent with operating the imaging module to capture images of the façade.

The method may involve successively repeating the steps of moving the trolley along the one or more paths, and operating the winch mechanism, to cause the imaging module to successively traverse laterally, and vertically, across the façade.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps, unless the context of the disclosure indicates otherwise.

It will be appreciated embodiments may comprise steps, features and/or integers disclosed herein or indicated in the specification of this application individually or collectively, and any and all combinations of two or more of said steps or features.

### BRIEF DESCRIPTION OF THE DRAWINGS

Embodiments will now be described by way of example only with reference to the accompany drawings in which:

FIGS. 1 and 2 are perspective and front views, respectively of a first embodiment of a building envelope access system mounted to a building.

FIG. 3 is a detailed side view of the system of FIG. 1.

FIG. 4 is a top view of the system of FIG. 1.

FIG. 5 is a front view of a support assembly of the system shown in the previous figures, illustrating rotation in a tension plane.

FIG. 6 is a side view of the support assembly shown in FIG. 5, illustrating rotation about a position axis.

FIG. 7 is a perspective view of part of the support assembly shown in FIGS. 5 and 6.

FIGS. 8 and 9 are rear and top views, respectively of the support assembly of FIG. 7.

FIGS. 10 and 11 are exploded views of the support assembly shown in FIGS. 7 to 9.

FIGS. 12 to 14 are detailed exploded views of the support assembly of FIGS. 7 to 11.

FIGS. 15 and 16 are detailed perspective views of the support assembly of FIGS. 7 to 14.

FIG. 17 is a perspective view of a sub-assembly of the support assembly shown in FIGS. 7 to 16.

FIGS. 18 and 19 are perspective views of components of the sub-assembly of FIG. 17.

FIG. 20 is a front view of a carriage and a functional platform of the system of FIGS. 1 to 4.

FIGS. 21 to 24 are perspective, front, side and top views, respectively, of the carriage shown in FIG. 20.

FIGS. 25 to 30 are perspective, side, top and rear views, respectively of the functional platform of FIG. 20.

FIG. 31 is a schematic view illustrating operation paths of the functional platform.

FIGS. 32 and 33 are perspective and side views of a propulsion system pf the functional platform;

FIG. 34 is a detailed perspective view of a mount of the propulsion system of FIGS. 32 and 33.

FIGS. 35 to 37 are perspective, side and front views, respectively, of an alternative support system for supporting a platform at an elevated position relative to a building.

FIGS. 38 and 39 are perspective and side views, respectively, of a second embodiment of a building envelope access system mounted to a building.

FIGS. 40 to 42 are perspective, front and side views, respectively, of a functional platform of the system shown in FIGS. 38 and 39, where the platform is in a deployment configuration.

FIGS. 43 and 44 are perspective and side views, respectively, of the functional platform of FIGS. 40 to 42, where the platform is in an operation configuration.

FIGS. 45 and 46 are perspective views of a carriage of the system shown in FIGS. 38 and 39.

FIG. 47 is a perspective view of a component of the carriage shown in FIG. 48.

FIGS. 48 and 49 are perspective and side views, respectively, of an alternative embodiment of the support system shown in FIGS. 35 to 37.

FIGS. 50 and 51 are perspective and side views, respectively, of a further alternative embodiment of the support system shown in FIGS. 35 to 37.

FIGS. 52 and 53 are exploded views of components of the systems shown in FIGS. 48 to 51

For ease of reference in the figures and throughout the description, corresponding features have been given corresponding reference numerals.

### DESCRIPTION OF EMBODIMENTS

Reference throughout this specification to “some embodiments” or “an embodiment” means that a particular feature, structure or characteristic described in connection with the embodiment is included in at least one disclosed embodiment. Thus, appearances of the phrases “some embodiments” or “various embodiments” throughout this specification are not necessarily all referring to the same embodiments, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

It is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a functional path between an output of A and an input of B which may be a path including other devices or means. “Coupled” may mean that two or more elements are either in direct physical or electrical contact, or that two or more elements are not in direct contact with each other but yet still co-operate or interact with each other.

In the drawings, reference numeral 1 generally designates a system 1 for positioning a functional platform 5 at an elevated position relative to external walls of a building 2, such as to allow surveying or maintaining the building 2. The system 1 includes an elongate, flexible element 10, a carriage 4 mountable to the flexible element 10 and operable to move along the flexible element 10, the carriage 4 configured to suspend the functional platform 5 operatively below the carriage 4, and a pair of support assemblies 6. Each support assembly 6 includes a mount 14 configured to be fixed to the building 2 to define a position axis 7, and an elongate support member 13 configured to connect to the mount 14 to be rotatable about the position axis, the support member defining a free end 11 configured to support the flexible element 10. The system 1 also includes a retraction mechanism engageable with the flexible element 10 and operable to retract the flexible element 10.

Mounting the support assemblies 6 at a top of the building 2 to be spaced apart, and securing the flexible element 10 between a fixed position, against the free end 11 of each support member 13, and to the retraction mechanism, and operating the retraction mechanism, causes the flexible element 10 to tension between the support members 13 to allow arranging the flexible element 10 above the top of the building 2, and allow mounting the carriage 4, carrying the functional platform 5, on the flexible element 10.

In the figures, the flexible element 10 is configured as an inextensible zip line 10, typically formed from a high-strength synthetic fiber line, for example, a Dyneema rope. In other embodiments (not illustrated), the flexible element comprises any of a cable, rope, wire, cord, strap, and chain. The zip line 10 is arrangeable to support the carriage 4 and guide its movement. The zip line 10 may also be used as a drive line by the carriage 4 to facilitate lateral movement between the support members 13. In the illustrated embodiments, a single zip line 10 is utilised as both the guide line and the drive line. In other embodiments (not illustrated), the zip line acts only as the guide line and one or more separate drive lines are provided to allow causing lateral movement of the carriage 4. In such embodiments, the guide line may be a relatively thick line to enhance strength and support, and the drive line may be a relatively thin line to reduce friction.

In the illustrated embodiment, each support member 13 is configured as an elongate mast, or mounting arm 13. The zip line 10 may be fixed to a connection point at the free end 11 of the mounting arm 13 of each support assembly 6. Each connection point may be defined by an end cap secured to one of the mounting arms 13. Alternatively, the zip line 10 may be routed via the end caps of the mounting arms 13 to an alternatively located connection point, such as at the base of the mounting arm 13. In some embodiments, the end caps of the mounting arms 13 incorporate a pulley arrangement 20 to route the zip line 10 to the base of the arm 13 to redirect force exerted on the arm 13 by the zip line 10. In such embodiments, the position of the pulley mechanism 20 typically causes each arm 13 to be handed—such that the pair of arms 13 are a mirror-image of each other. When configured in this way, a first arm 13 must be mounted at the left side of the system 1 and a second arm 13 must be mounted at the right side of the system 1 to allow supporting the zip line 10 via the pulley mechanisms 20.

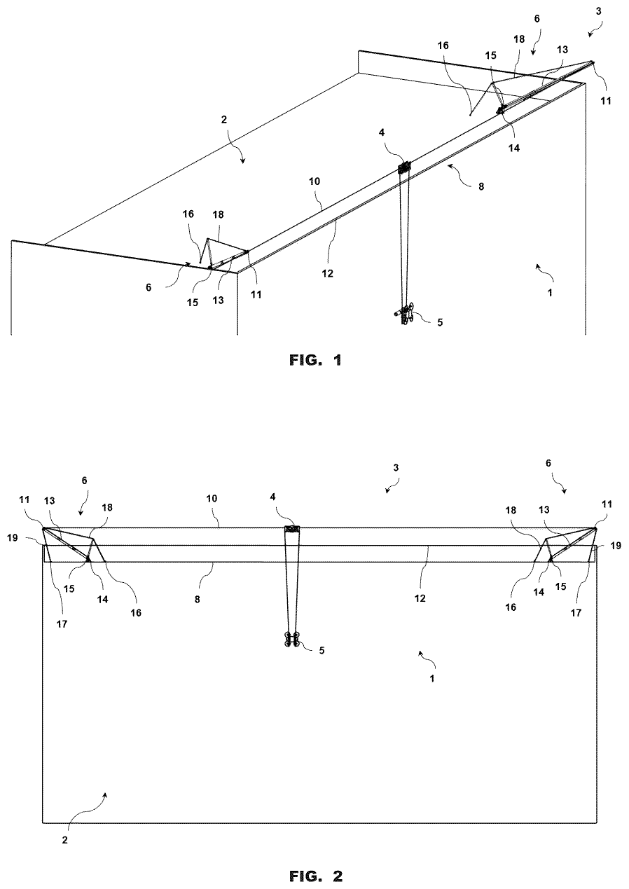

Referring to FIGS. 1 to 4, the support assembly 6 is rotatably mountable to a top surface of a building 2 to rotate about the position axis 7. In this illustrated embodiment, the position axis 7 is defined by the mount 14. The mount 14 is configured to be mounted to a planar surface, such as a roof, and arrange the axis 7 to be substantially parallel with the planar surface, in this embodiment being the top surface of the building 2, to be operatively horizontal, so that the support assembly 6 may rotate towards or away from a live edge 8 of the building 2. It will be appreciated that, in other embodiments (not illustrated), each support assembly 6 is rotatably mountable to the building 2 about the position axis 7 arranged to be perpendicular to the top surface of the building 2, to be operatively vertical, so that the support assembly 6 can rotate towards or away from the live edge 8 of the building 2. In either configuration, the support member 13 is mountable to one of the mounts 14 so that, in use, the support members 13 are arrangeable to diverge away from each other. This causes each support member 13 to be compressed by force exerted on the member 13 by the tensioned zip line 10, such that each support member 13 is urged towards the associated mount 14. This can advantageously inhibit the ends 11 of the arms 13 being drawn towards each other to maintain zip line 10 tension. As a result, this can enhance controlling the vertical position of the carriage 4 and position of the suspended functional platform 5.

Best shown in FIG. 5, each support assembly 6 is typically configured to rotate about a tension axis 9 to tension the zip line 10 in a tension plane between a pair of connection points, in this embodiment defined at the free end 11 of each arm 13, so that the zip line 10 is arranged above the top of the building 2. Arranging the zip line 10 in this way can allow the functional platform 5 to access to the top of the building 2. The carriage 4 is engageable with the zip line 10 and configured to move along the zip line, between the connection points 11. The functional platform 5 is suspended from the carriage 4 and, in combination with moving the carriage 4, is operable to be move about the envelope of the building 2. When the system 1 is installed and operated in this way, the functional platform 5 can efficiently conduct a wide range of tasks to avoid human exposure to potentially dangerous environments, such as inspection and/or surveying of the external walls of the building, including scanning or mapping at least a portion of the building to generate a 2D or 3D digital model, imaging the building, cleaning the building, repairing the building, including painting or coating the building, and installing objects to the building, such as sensors or explosives, for example, to assist with demolition of the building or defence operations conducted on or in the building.

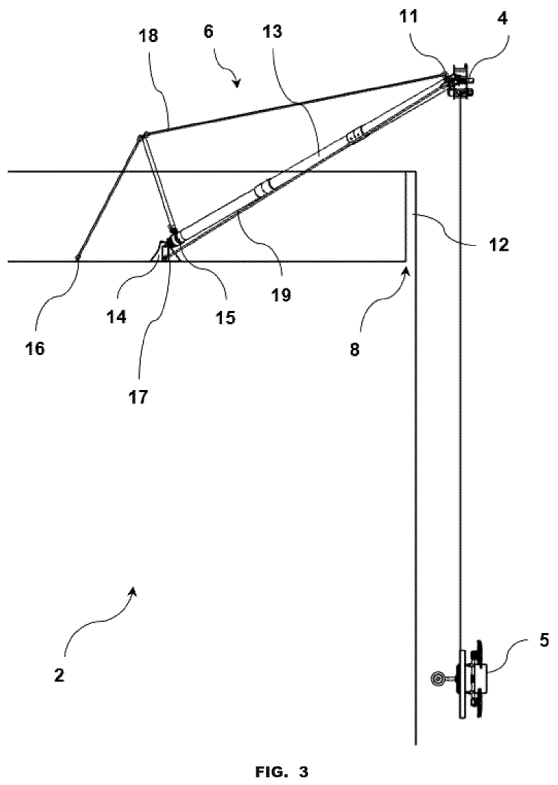

Each support assembly 6 is typically installed to the building 2 so that the mounting arms 3 are rotated about the position axis 7 to initially be inboard of the periphery of the building 2. Once installed behind the edge 8 of the building 2, the support assembly 6 may be rotated about the position axis 7, as illustrated in FIG. 6, whilst maintaining the zip line 10 at tension in the tension plane, as shown in FIG. 5, to bring the zip line 10, carriage 4 and functional platform 5 beyond the edge 8 of the building 2 to provide access to the envelope. As seen in FIG. 3, the system 1 can support a load in the form of the functional platform 5 at an elevated position above the ground, beyond the live edge 8 of the building 2. The configuration of the arms 3 carrying the zip line 10 allows deploying the zip line 10, carriage 4 and platform 5 over a barrier or railing 12 on the top surface of the building 2 and beneath the level of top surface of the building 2. Advantageously, the system 1 can support the load at a variety of elevated locations at working positions about the envelope of the building 2.

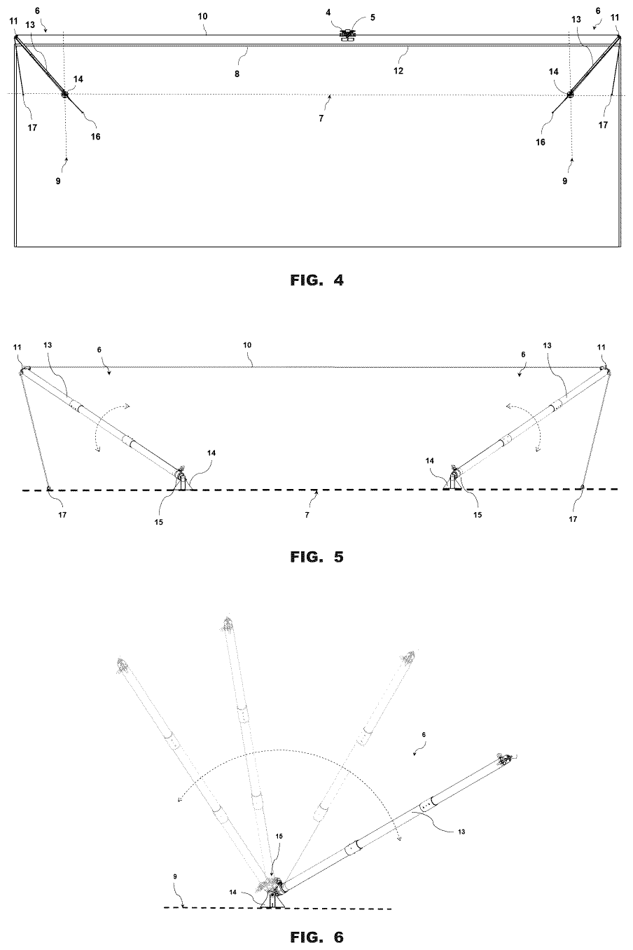

Best shown in FIG. 4, each support assembly 6 includes a mounting arm 13 rotatably mountable to the top surface of the building 2 such that the support assemblies 6 are secured at adjacent corners of an edge 8 of the building. Each of the mounting arms 13 are respectively mounted to the mount 14, which may be embodied as a bracket or, as illustrated a base plate 14, by way of a coupling 15. In some applications, the base plates 14 are fixed to the surface at approximately two metres from the periphery of the building 2 and the mounting arms 13 are dimensioned to be approximately four metres long. Accordingly, the arms 13 are rotatable about the position axis 7 to bring the zip line 10 beyond the periphery of the building 2. It will be appreciated that the position of the base plates 14 and the relative dimensions of the mounting arms 13 may be adjusted to enable the zip line 10 to extend over any ledges or barriers 12 and sufficiently beyond the edge 8, as required.

In the illustrated embodiments, the zip line 10 is fixed between a fixed position, across both support assemblies 6 and to the retraction mechanism so that the zip line 10 can be tensioned between, and elevated by, the support assemblies 6. The retraction mechanism typically includes a manually operable ratchet mechanism, or powered winch mechanism, either of which may be mounted to one of the support assemblies 6, and the fixed position be defined by the other support assembly 6. It will be appreciated that the retraction mechanism and/or fixed position may alternatively be located on the building 2 itself. In some embodiments (not illustrated), the zip line 10 may extend between a single fixed connection point, such as defined by an anchor point fixedly secured to the building or other static structure, and a moveable connection point on the distal end 11 of a single mounting arm 13. In such embodiments, only a single support assembly 6 is required. Generally, the illustrated embodiment comprising a pair of support assemblies 6 is preferred as this is less complex to install and remove from the building 2 and is therefore more readily moved between buildings and/or installed in different positions relative to the building 2.

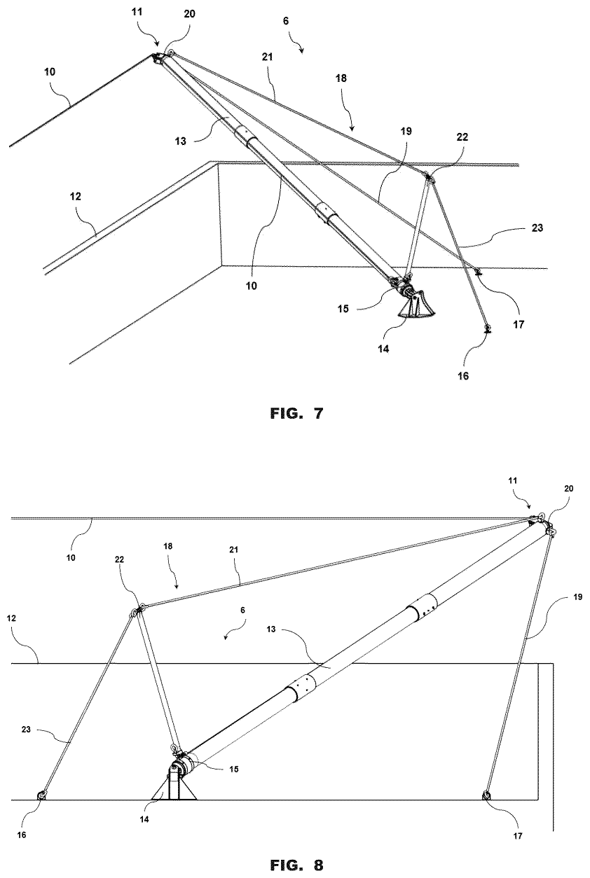

Referring to FIGS. 7 to 9, each support assembly 6 may include a back support anchor 16 and at least one tension anchor 17 fixedly secured to the building 2 adjacent each base plate 14. Each back support anchor 16 is arranged to secure an adjustment member between the building 2 and the respective mounting arm 13 to support and maintain the mounting arm 3 at a predetermined orientation about the position axis 7. Each tensioning anchor 17 is arranged to secure a restriction member between the building 2 and the respective mounting arm 13 to maintain a tension force on the respective mounting arm 13, particularly by inhibiting the free ends 11 of the arms 13 moving towards each other. Each tension anchor 17 is positioned such that, in use, the tension anchor 17 is inward from the distal end 11 of the respective mounting arm 13 towards the associated base plate 14.

The back support anchors 16 and tension anchors 17 are specifically selected and installed to withstand tension forces, whereas conventional anchors are only designed for shear loads and are not able to withstand tension forces. For collared eyebolts, this translates to pull angles not exceeding 20 degrees to the surface in which the bolt is installed which is insufficient for use as the present back support or tension anchors. In particular, the back support anchors 16 and tension anchors 17 may be defined by Petzl Coeur bolts which are configured to resist substantially high tension forces relative the surface in which they are installed. Advantageously the anchors 16, 17 are able to resist a tension force pulling up from the anchor point 16, 17 and thus may provide back support and tensioning of the mounting arms 13 and zip line 10.

Advantageously, the positioning of the tension anchors 17 and the configuration of the mounting arms 13 redirects the tension force of the tensioned zip line 10 along the length of the mounting arm 13 such that the mounting arm 13 is compressed. Accordingly, a light weight and rigid support structure 3 may be used to support the load at the elevated position.

Referring to FIG. 5, the support members 13 are rotatable across a tension plane about the tension axes 9 in order to tension the zip line 10 between the two connection points at the distal end 11 of each mounting arm 13. In the illustrated embodiments, each mounting arm 13 may rotate about a respective tension axis 9, preferably to symmetrically tension the zip line 10.

Referring to FIG. 6, each support assembly 6 is also rotatable about the position axis 7 to bring a distal end 11 of the mounting arm 13, carrying the zip line 10, towards or away from the edge 8 of a building 2. Best shown in FIG. 4, each of the mounting arms 13 are typically mounted to the building such that they are rotatable about a common position axis 7. The zip line 10 is tensioned to be parallel to the position axis 7.

The support assemblies 6 are configured such that the zip line 10 may be tensioned and the support members 13 rotated about the position axis 7 whilst maintaining tension in the tension plane. Advantageously, this in-plane tension enables the support assemblies 6 to reposition the zip line 10 whilst retaining tension. Accordingly, the system 1 may be set up when pivoted away from the edge 8 of the building 2, including mounting the carriage 4 and platform 5 on the zip line 10, and the support assemblies 6 then rotated to reposition the zip line 10 while tensioned.

In alternative embodiments (not illustrated), one end of the zip line 10 may be fixed in place and the other end, or a location along the zip line 10, rotated by a support assembly 6 relative to the fixed end. The relative motion of the connection points of the zip line 10 may reposition and tension the zip line 10. For example, one end of the zip line 10 may be fixed to the building 2 and the other end of the zip line 10 connected to a mounting arm 13. The mounting arm 13 may thus rotate away from the fixed connection point to tension the line 10, and may also rotate orthogonally to re-position the zip line 10.

In yet other embodiments (not illustrated) where the position axes 7 are arranged to be operatively vertical, each mounting arm 13 may be mounted to a turntable operable to controllably rotate the arm 13 about the axis 7. In such embodiments, rotating the arms 13 about the axes 7, such as by operating a motor engaged with one or both turntables, can cause tensioning the zip line 10 between the arms 13 and repositioning the zip line 10 relative to the edge 8 of the building 2. In some embodiments (not illustrated), a further motor is associated with each arm 13 to pivot the arm 13 about the respective tension axis 9. Preferably the arms 13 are rotated to an operational position such that the arms 13 are arranged to diverge away from each other to cause compression of each arm 13 towards the position axis by the tensioned zip line 10 and, as a result, enhance maintain tension of the zip line 10.

Referring again to FIGS. 7 and 8, each support assembly 6 may include a plurality of additional braces and struts to enhance supporting the load and/or facilitate positioning of the load. The braces and struts are arranged to limit rotation of the support member 13 about one or both axes 7, 9. In the illustrated embodiments, each support assembly 6 is associated with a separate zip line 10, support lines 18, and tension lines 19. In alternative embodiments (not illustrated), the various lines may be defined by a continuous length secured at respective points. In yet other embodiments (not illustrated), the support lines 18 and/or tension line 19 are substituted with other suitable static or adjustable retention structures, such as a gas strut or motor operable to adjust rotational position of the support member 13 about the position axis 7, or a substantially rigid member, such as a bar, arranged to secure the support member 13 about the tension axis 9.

In the illustrated embodiment, each support assembly 6 also includes a restriction member in the form of a flexible tensioning line 19 connecting the end cap of the mounting arm 13 to the tension anchor 17 fixed into the top surface of the building 2, such that the tension line 19 provides a brace to restrict movement of the end caps of the support assemblies 6 towards each other, which could decrease tension of the zip line 10. The tension line 19 may incorporate an integral ratcheting portion, for example, a ratchet strap. Alternatively, the tension line 19 may be pulled though the tension anchor 17 to rotate the mounting arm 13 and tension the zip line 10, and then be tied off at the tension anchor. In this way, the mounting arms 13 may function as lever arms for tensioning the zip line 10 wherein the tension line 19 is configured to facilitate tensioning the zip line 10 and then maintaining that tension. Each mounting arm 13 may include a tensioning mechanism for symmetrically tensioning the zip line 10 from alternate ends of the zip line 10. Further alternatively, the tension line 19 may be a fixed inextensible length arranged to limit rotation of the support member 13 about the tension axis 9, and the zip line 10 be associated with a ratchet mechanism mounted to the support member 13 so that operating the ratchet mechanism tensions the zip line 10 and, in turn, causes pivoting of the arm 13 until tensioning the tension line 19.

Each support assembly 6 may include an adjustment member, in the illustrated embodiment in the form of a support line 18, configured to position the mounting arm 13 at a predetermined angle or orientation about the position axis 7. The support line 18 is arranged to limit the extent of rotation of the mounting arm 13 about the axis 7 to allow controlling position of the zip line 10 relative to the edge 8 of the building 2.

The support line 18 is arranged to support a load applied to the support assembly 6 and/or the zip line 10. The support line 18 is typically connected between the free end 11 of the mounting arm 13 and a support anchor 16, and spaced from the mounting arm 13 by a rigid strut, in this embodiment in the form of a back support arm 22. In the illustrated embodiments, the support line 18 comprises a flexible upper support line 21 connected to the end cap 20 and the back support arm 22, and a flexible lower support line 23 connected between the back support arm and the anchor 16. Each support line 21, 23 is configurable to act as a brace to impart rigidity to the mounting arm 13. It will be appreciated that in some embodiments (not illustrated), one or both of the support lines 21, 23 are replaced by a rigid member. It will also be appreciated that in other embodiments, the support line 18 is a continuous line, such as a strap, rope, or chain, from the end 11 of the arm 13 to the anchor 16. Most typically, the lower support line 23 is configured to be length-adjustable, such as by manually adjusting the line 23 and tying off, or by operating an associated adjustment mechanism, such as a ratchet mechanism or winch. In some embodiments, a single adjustment mechanism, such as an electrically powered winch, is connected to the support line 21 of both support assemblies 6 so that operation of the adjustment mechanism synchronises adjusting the rotational limit of the support members 13 about the position axes 7.

The upper support line 21 may be either a static or dynamic line. Generally, the upper support 21 line is a static line of a predetermined length sufficient to maintain the back support arm 22 at a substantially right angle to the mounting arm 13. The lower support line 23 is configured to maintain the mounting arm 13 at a desired angle about the position axis 7. The lower support line 23 is preferably a substantially dynamic line, for example, a polyester rope which enables a degree of stretch. Advantageously the lower support line 23 may allow the system to absorb energy in the event of a shock load, dramatically reducing peak force.

The angle of the mounting arms 13 and correspondingly, the position at which the zip line 10 is held may be varied by rotating the mounting arms 13 about the position axis 7. Such rotation may be performed by increasing or decreasing the effective length of the lower support line 23, for example, by using a ratchet strap. In alternative embodiments, the lower support line 23 may incorporate a winch mechanism to wind or unwind the length of the lower support line. Alternatively, a fixed length support line 23 may be relied on to maintain the mounting arms 13 at a desired angle about the position axis 7 in use. A limiting mechanism 24 in the base plate 14, as will be outlined in detail below, may be used to maintain the mounting arms 13 at a set up angle, assembly angle, mounting angle, or other desired angle.

The back support arm 22 is rotatably mounted about a third axis defined by the mounting arm 13 so that, in use, the back support arm 22 is at generally right angles to the mounting arm 13. The back support arm 22 provides leverage as a fulcrum point for the support line 18 in order to secure the mounting arm 13 at a desired position. Advantageously, the back support arm 22 being rotatably mounted to the mounting arm 13 by way of the coupling 15 enables the back support arm to pass shock forces exerted on the mounting arm 13 from the upper support line 21 to the lower support line 23. The back support arm 22 may be removable from the mounting arm 13 to facilitate transport and storage.

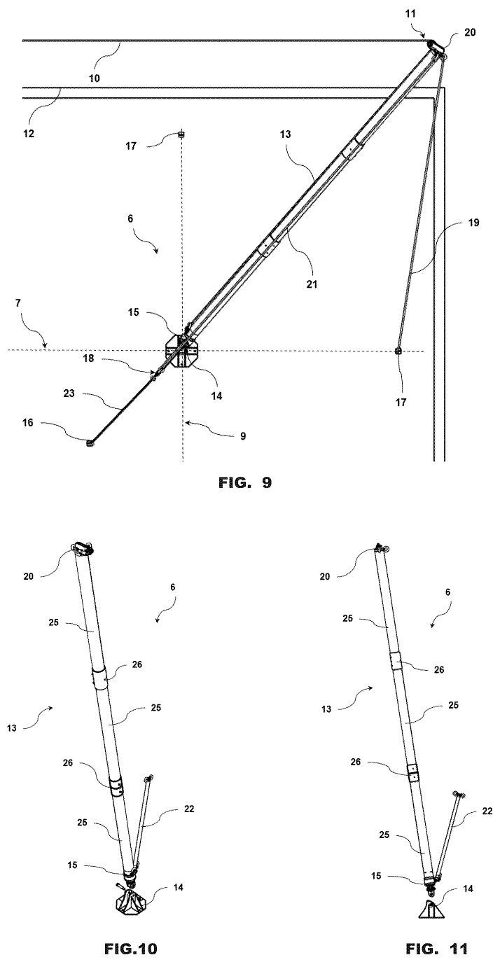

As best illustrated in FIG. 9, each base plate 14 and mounting arm 13 may be associated with a back support anchor 16 and a pair of tension anchors 17. The support assembly 6 is configured such that the mounting arm 13 may be used to support a zip line 10 along either of the adjacent edges of the building 2 by utilizing the support anchor 16 and one of the tension anchors 17. In FIG. 9, the building 2 is envisaged as having right angle corners and the pair of tension anchors 17 positioned equidistantly from each adjacent edge and at a substantially right angle to each other relative to the mount 14. The mounting arm 13 may then support the zip line 10 beyond the north edge of the building 2, secured at a predetermined position angle by the back support anchor 16 and tensioned utilising one of the tension anchors 17. Thus, the system 1 may provide access to the north face of the building. The same mounting arm 13 may also be used to support a zip line 10 beyond the east edge of the building 2, secured at a predetermined position angle by the same back support anchor 16, and tensioned utilising the other of the tension anchors 17.

Whilst not illustrated, it will be appreciated that a configuration of four mounting arms 13 rotatably mounted to base plates 14 at each corner of a rectangular building could provide access to the full building envelope. Similarly, with buildings of other shapes, the positioning of the tension anchors 17 and back support anchor 16 for each base plate 14 may be configured such that each mounting arm 13 may be utilised to support a zip line 10 beyond both respective adjacent edges of the building 2. For example, where the base plate 14 is arranged at a right angle corner of the roof of the building 2, a first tension anchor 17 and first back support anchor 16 may be secured to allow positioning a support arm 13, mounted to the base plate 14 in a first orientation, to extend relative to a first side of the building 2, and a second tension anchor 17 and second back support anchor 16 be secured to allow positioning the support arm 13, mounted to the base plate 14 in a second orientation, to extend relative to a second side of the building 2. Advantageously, configuring the base plate 14 and position anchors 16, 17 to allow mounting the same support arm 13 to support the zip line 10 beyond two, or more, adjacent edges of a building 2 can minimise the number of base plates 14 required to access the envelope of the building 2. As a result, this can limit the number of penetrations of the top surface and roof membrane of the building 2 required, which could otherwise affect weatherproofing of the building.

FIG. 10 shows a perspective view of a mounting arm 13 rotatably mountable to a base plate 14 via the coupling 15, and the back support arm 22 rotatably mounted to the arm 13, and FIG. 11 shows a side view thereof.

In this embodiment, the mounting arm 13 is formed from a plurality of pole sections 25 joined by collars 26. In general, the mounting arm 13 is approximately four metres long and includes three pole sections 25, each approximately one and a third metres in length. Where the various requirements of a building or installation call for longer mounting arms 13, additional pole sections 25 may be added. The collars 26 are bolted together to respectively join the pole sections 25 and may be unbolted to disassemble the mounting arm 13. The mounting arm 13 is, in use, bolted to the coupling 15 and may be unbolted when not in use. Being able to rapidly assemble and disassemble the mounting arm 13 enables the system 1 to be portable.

The configuration of the mounting arms 13, tension line 19, support lines 21, 23 and anchors 16, 17 mean that the mounting arm 13 is in compression when in use. This allows the mounting arms 13 to be made from light aluminium while maintaining sufficient strength. The coupling 15 and back support arm 22 are also made of lightweight aluminium. This light weight, collapsible configuration enhances portability of the system 1 between different buildings as, for example, the mounting arms 13 and lines can be manually carried by a person between buildings where base plates 14 and anchors 16, 17 are installed.

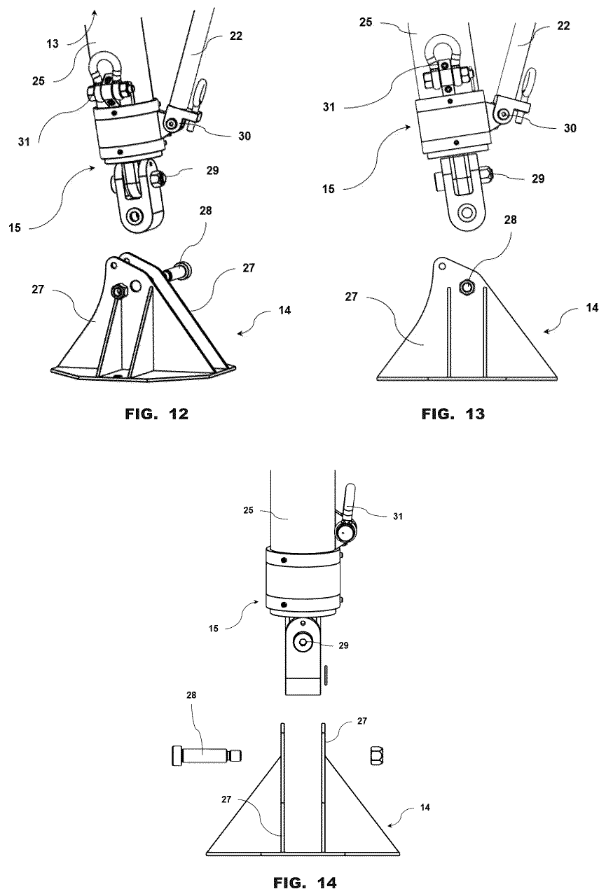

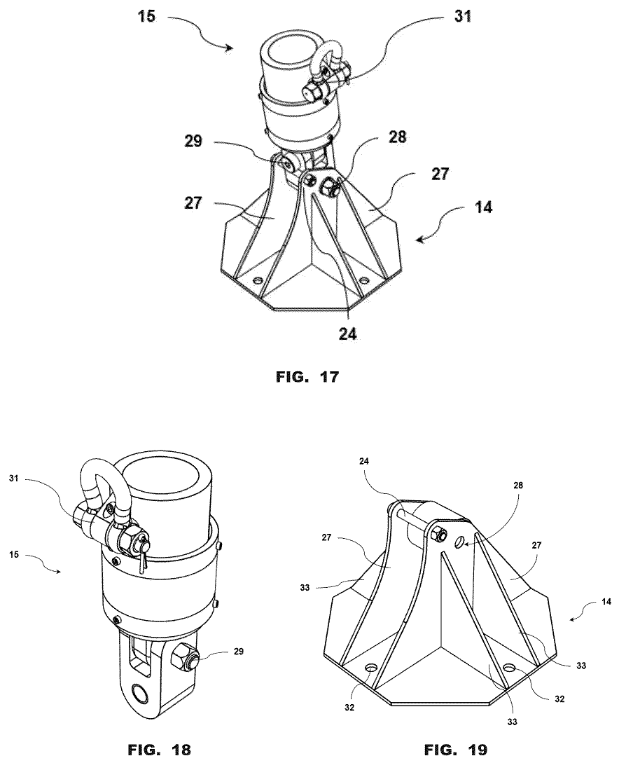

As shown in FIGS. 12 to 16, the mounting arm 13 is rotatably mountable to the base plate 14 by way of the coupling 15. In this embodiment, the base plate 14 includes a pair of generally trapezoidal mounting flanges 27 for receiving a mounting axle 28 therebetween. The mounting axle 28 is used to rotatably mount the coupling 15 to the base plate 14 to define the position axis 7. The mounting axle 28 may comprise a bolt with a smooth portion for the coupling 15 to rotate around and a threaded end portion to receive a nut for fixing to the base plate 14. Advantageously, the coupling 15 is releasably attached to the base plate 14 by the mounting axle 29 to facilitate transporting the mounting arm 13 between different base plates 14.

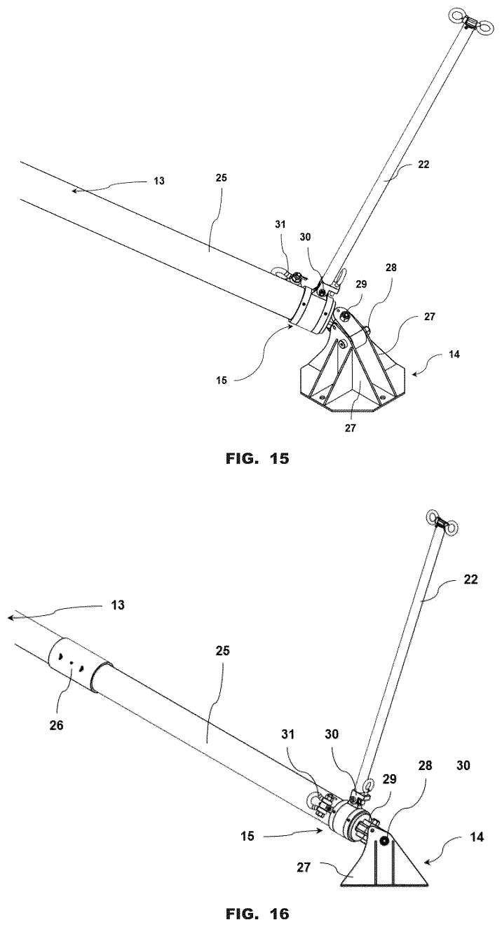

Referring to FIGS. 15 to 18, the coupling 15 includes a pivot axle 29 in addition to the mounting axle 28, the pivot axle 29 defining the tension axis 9. In use, the coupling 15 enables the mounting arm 13 to rotate about the position axis 7 to position the zip line 10, and enables the mounting arm 13 to rotate laterally to the pivot axis 7 about the tension axis 9 to tension the zip line 10. Similarly to the mounting axle 28, the pivot axle 29 may comprise a nut and bolt arranged through the coupling 15 to facilitate ease of installation and portability. In alternate embodiments (not illustrated), the pivot axle 29 is integrally formed with, or permanently attached to, the coupling 15.

In the illustrated embodiment, the coupling 15 further includes a support connection point 30 which defines the third axis for rotatably mounting the back support arm 22 about. In alternative embodiments, the support connection point may be included on the base plate 15 or the lower most section of the mounting arm 13. The coupling 15 also includes a tie down point 31 which may be used to define the fixed location for securing an end of the zip line 10. In alternative embodiments, the zip line 10 may be fixedly secured to the base plate 15. As outlined above, the pulley end cap 20 redirecting the zip line 10 to the tie down point 31 on the coupling 15 enables the redirection of force in the system 1 and provides rigidity to the mounting arms 13 in use.

As best seen in FIG. 19, the base plate 14 typically includes a plurality of apertures 32 for receiving fasteners to fix the base plate 14 to a surface. The base plate 14 further includes a plurality of support flanges 33 for reinforcing and supporting the mounting flanges 27. The support flanges 33 can minimise the foot print and mounting point for the support assembly 6, which can enhance ease of installation.

The mounting flanges 27 carry a rotation limiting mechanism, in the form of a rigidly mounted stop bar 24, arranged at one side of the mounting axle 28. The stop bar 24 is arranged to abut the coupling 15 to limit the range of motion of the mounting arm 13 about the position axis 7. Accordingly, the position of the limiting mechanism 24 can be configured to coincide with a desired position of the mounting arms 13 supporting a zip line 10 relative to a building 2, such as a defined height and/or space from the edge 8, or can instead be arranged to define a set up position of the mounting arms 13. For example, the stop bar 24 may hold the mounting arm 13 at a substantially vertical position to facilitate initial set up of the zip line 10 and support assembly 6. In other embodiments, multiple stop bars may be installed in the base plate 14 to define one or more positions about the position axis 7. In yet other embodiments, the stop bar 24 or any other limiting mechanism is omitted and the system 1 instead rely on the support lines 21, 23 to position the mounting arm 13.

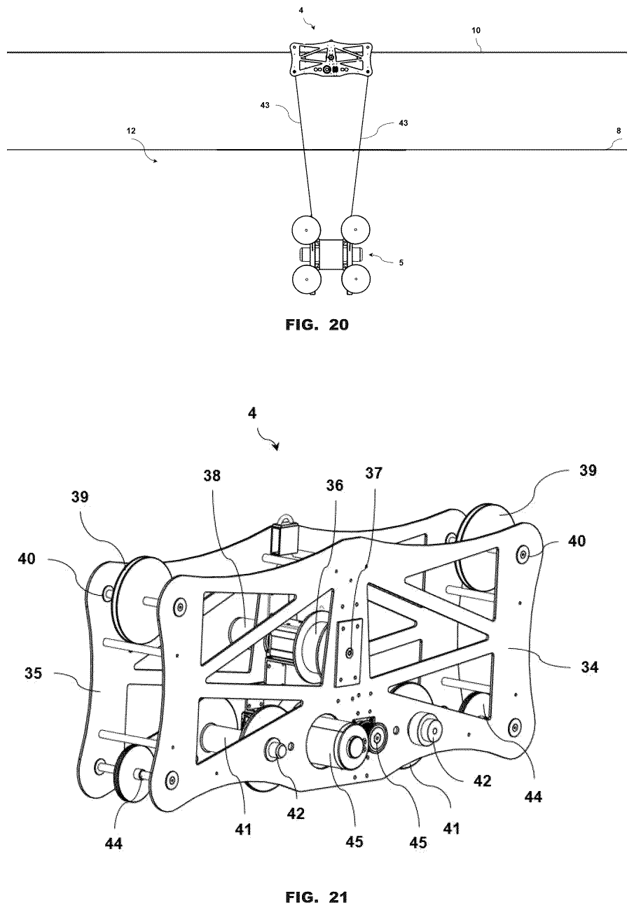

FIG. 20 illustrates the carriage 4 arranged on the zip line 10 and the functional platform suspended below the carriage 4. The carriage 4 is configured to move laterally along the length of the zip line 10 and is typically configured to raise and/or lower the functional platform 5. The arrangement of the zip line 10 to be spaced beyond the edge 8 of the building 2 allows the carriage 4 and platform 5 to move past an obstacle on the roof or extending from a wall of the building 2. Furthermore, arranging the carriage 4 to move laterally along the zip line 10 and provide vertical movement of the functional platform 5 can allow the platform 5 to access the entire side of the building 2, including full façade coverage extending to the top, bottom and outside edges, as well as corners. This can be particularly useful where, for example, windows extend to the periphery of a side of a building 2, as the platform 5 can access and clean the entirety of each window.

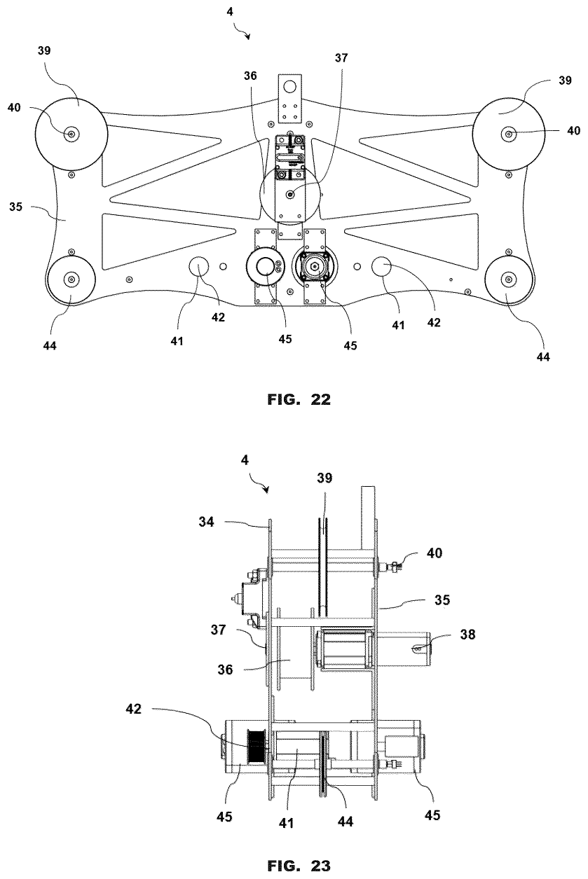

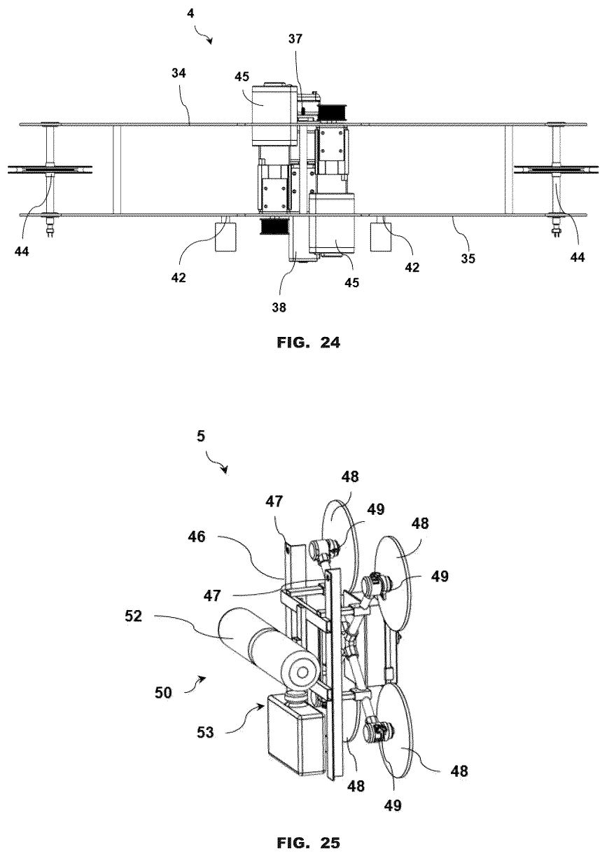

Referring to FIGS. 21 to 24, the carriage 4 includes a substantially rectangular front frame plate 34 and rear frame plate 35. The carriage 4 includes a drive mechanism in the form of a drive wheel 36 rotatably mounted to a drive axle 37 substantially centrally between the front and rear frame plates. The drive wheel 36 is configured to be engaged with the zip line 10 to pull the carriage 4 along the zip line. The drive wheel 36 is coupled to a drive motor 38 mounted to the carriage 4, the drive motor 38 is a bi-directional motor which may rotate the drive wheel 36 in either direction to move the carriage 4 back and forth along the zip line.

The carriage 4 further includes a guide mechanism in the form of a pair of guide wheels 39 rotatably mounted to respective guide axles 40 between the top corners of the front and rear frame plates. The guide wheels 39 are configured to engage the zip line 10 to support the carriage 4 during its movement along the zip line 10. The drive wheels 36 and guide wheels 39 may engage the same line of the zip line 10, or may engage separate drive lines and guide lines of the zip line 10. Advantageously, the guide wheels 39 are positioned above the drive wheel 36 and are at adjacent corners of the carriage 4 providing support to the carriage 4. The guide wheels 39 are typically non-driven, passive wheels for supporting the carriage 4. The drive wheels 36 may include an encoder to record their rotation thereby to determine movement of the carriage.

In order to suspend a load from the carriage 4, the carriage 4 includes a suspension mechanism in the form of a pair of suspension wheels 41 rotatably mounted to respective suspension axles 42 between a bottom portion of the front and rear frame plates 34, 35. The suspension wheels 41 are configured to engage a pair of suspension lines 43 to raise and/or lower the load via respective suspension pulleys 44 between the bottom corners of the front and rear frame plates 34, 35. Each suspension wheel 41 includes a respective suspension motor 45 mounted to the carriage 4. Each suspension motor 45 is a bi-directional motor which may rotate the respective suspension wheel 41 in either direction to move the load up and/or down. The suspension motors 45 and wheels 41 may operate independently to tilt the load and/or to compensate for disturbances to the load. In general, the suspension motors 45 and wheels 41 operate symmetrically to raise and/or lower the load in a level manner. The suspension pulleys 44 re-direct the force of the suspension wheels 41. The suspension lines 43 may be substantially static lines and each of the suspension lines may include a respective a shock absorber in the form of an energy absorbing distal dynamic portion of the line. In use, the energy absorbing line is connected to the load in order to suspend the load from the suspension lines and when in normal operation is static and unused. In the case of an unplanned fall from a sufficient height the energy absorbing line will slow catch the load and reduce its velocity to zero over a distance, allowing a controlled deceleration and preventing excessive shock forces being placed onto the system.

The suspension pulleys 44 enable the suspension wheels 41 to be positioned substantially centrally and below the drive wheel 36 ensuring a balanced centre of gravity to the carriage 4. The respective suspension motors 45 and drive motors 38 are also positioned centrally, to arrange the weight of the carriage 4 evenly about a central point. Each of the suspension pulleys 44 are positioned below a respective guide wheel 39 at the corners of the frame. Accordingly, in use, the weight of a load suspended from the carriage 4 is applied evenly across the frame and supported by the guide wheels 39. Advantageously, this configuration of guide 39, support 41, and drive wheels 36 provides a stable carriage for suspending a load therefrom.

The carriage 4 may further include a carriage controller (not shown) to control the drive and suspension wheels and motors. The carriage controller may include a transceiver for wirelessly sending and receiving signals, including controller signals and positioning information. The carriage may also include one or more sensors, including any of an inertial measurement unit (IMU), an accelerometer, a visual sensor, a proximity sensor, an ultrasonic sensor, as well as one or more encoders coupled to one or more of the guide, drive and/or suspension wheels. The carriage controller may implement a carriage positioning system to receive positioning information from one or more of the sensors and encoders, and be configured to fuse the positioning information from each sensor to estimate a unified position of the carriage 4. In some embodiments, the control and positioning of the carriage 4 may be provided remotely by an external controller. The carriage 4, controller, and respective motors may be powered by an on-board battery or by an external power supply.

FIGS. 25 to 30 illustrate one embodiment of the functional platform 5 in the form of a semi-autonomous drone platform or robot 5. The robot 5 may be configured to facilitate one or more functions about the external envelope of a building.

The robot 5 includes a frame 46 having a pair of suspension points 47 for receiving suspension lines 43 in order to suspend the robot 5 therefrom. The robot 5 further includes a propulsion and stabilisation system 48 in the form of four quadcopter style propellers mounted to the frame via gimbals 49. In use, the propellers 48 are generally normal to the surface of the building such that they may provide a thrust force generally orthogonal to the surface of the building. Each propeller 48 is driven by a respective motor. The robot 5 further includes a functional platform controller for guidance, navigation, control and stabilisation.

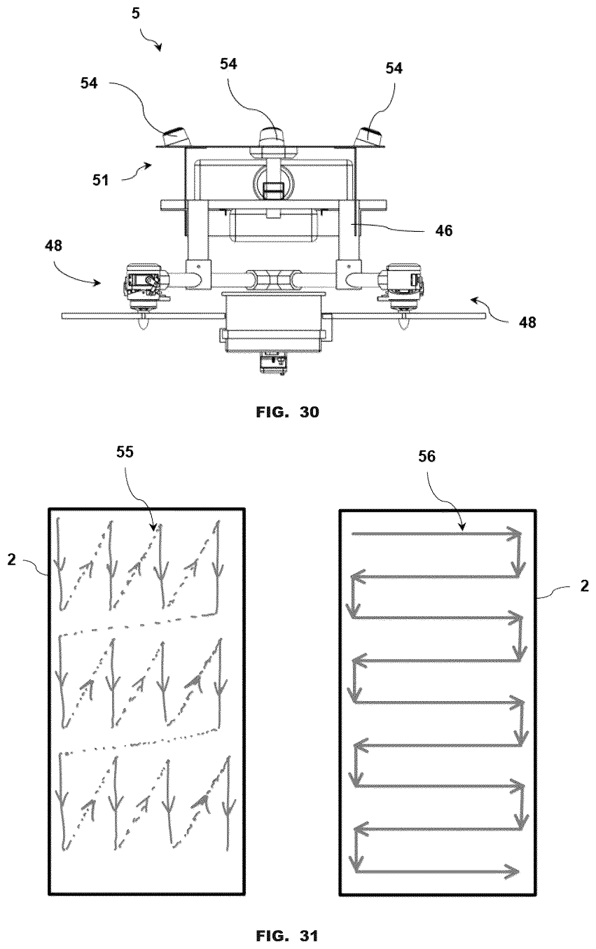

The robot 5 is a modular platform configured to releasably attach to and carry one or more utility modules, including one or more of a cleaning suite 50; a detection suite 51; an extension suite; and a spraying suite. For example, FIGS. 25 to 27 show the robot 5 including a façade cleaning suite module 50. FIGS. 28 to 30 show the robot 5 including a monitoring and detection suite module 51. Each of the cleaning suite, detection suite, extension suite, and spraying suite may be mounted to the frame 46 of the robot 5 and communicatively couple with the platform controller to allow remote operation of the attachments about the external envelope of the building 2.

The cleaning suite 50, such as that of FIGS. 25 to 27, may include a rotatable brush 52 mountable to the functional platform 5 and operable to clean surfaces, such as windows and/or façade structures of a building 2. During cleaning, the propulsion system 48 may be used to provide a contact force to urge the robot 5 against the building 2 to facilitate scrubbing by the brush 52. The cleaning suite 50 may further include a fluid supply and a cleaning spray system 53. The spray system 53 is operable in combination with the brush 52 to spray fluid onto a surface to enhance mechanical dislodging of particles or residue by the rotating brush 52. The fluid is preferably substantially pure water, for example, de-ionized water suitable for cleaning windows without leaving streaks or residue. Alternatively or additionally, the fluid may include one or more chemicals such as bleach, enzymes or quaternary ammonium compounds and/or detergents or surfactants, for example, for cleaning facades. The robot 5 may include multiple reservoirs holding multiple distinct fluids. The spraying system 53 may be configured to spray the fluid in one or more specific to clean the surface in conjunction with the brush 52. For example, arranging the spray system 53 to spray an operatively forward and upward stream of fluid from beneath the brush 52 can be particularly effective when cleaning windows.

The monitoring and detection suite 51, for example, as shown in FIGS. 28 to 30, may include a plurality of sensors 54. The sensors 54 may include one or more of optical sensors, including a camera, and infrared sensor, and/or ultrasonic sensors. Multiple optical sensors may be used to facilitate stereoscopic imaging of the external surface of a building 2. The sensors 54 may be configured to capture images of the external surface of the building 2 to facilitate dirt detection, façade inspection, crack detection, efflorescence detection, stain detection, corrosion detection, and/or thermal loss detection. Utilising one or more of the sensors 54, sensor fusion and a machine learning algorithm, the cleanliness of the window can be assessed. The cleaning attachments can then be operated to conduct additional cleaning if required. It will be appreciated that FIGS. 25 to 30 are illustrative only and that the respective functional attachments are not mutually exclusive. Indeed, the robot 5 may include and implement two or more suites of attachments simultaneously. Advantageously, in this way, the suite and/or suites of functional attachments may be attached and detached from the functional platform 5 in a modular fashion, as needed.

The sensors 54 are configurable to allow measuring a number of visual and structural aspects of a building. For example, multimodal optical sensors may be employed to allow measuring cracks, efflorescence, staining, and/or corrosion of the structure. Additionally or alternatively, thermal imaging sensors can be utilised to determine defects by monitoring the leakage of different temperature air through any cracks, or gaps in window seals or the like. The thermal imaging can be utilised to identify key areas of thermal energy loss or gain. This insight into the thermal signature of a building will aid in a building's ability to reduce its energy consumption through implementing various energy efficiency solutions. The detections by the various sensors 54 may be processed using machine learning techniques and image processing techniques.

In some embodiments (not illustrated), the robot 5 includes an extendable member, such as a cantilever arm, to extend the reach of any of the functional attachments, such as the brush 52. In some embodiments, the cantilever arm includes a grasping portion to enable remote mechanical manipulation, for example, for installations and repairs. Additionally or alternatively, the robot 5 may be configured to carry a reservoir of paint and a paint sprayer to enable the painting of a façade. Additionally or alternatively, the robot 5 may be configured to carry an insecticide spraying system to allow preventative or targeted spraying of insect infestation about the building 2. Moreover, the various sensors 54 of the detection suite 51 may also be utilised to facilitate remote and or autonomous control of the robot.

The propulsion and stabilisation system 48 is operable to produce thrust to urge the platform 5 towards and against the façade. The propulsion and stabilisation system 48 is further configured to maintain the position of the robot 5 during operation, counteracting contact forces against the face of the building 2 and environmental disturbances, such as caused by wind and/or thermals. In addition the propellers 48 are operable to allow manoeuvring around various obstacles such as mullions, balconies, and plant vents that may be encountered on the facade. The propellers 48 may be used to intermittently provide a thrust directed away from the building, allowing the robot 5 to manoeuvre over any such obstacles in its path. During such a thrust away, the robot 5 would swing in a controlled manner from the suspension lines 43 to create sufficient distance to move past the obstacle. The propellers 48 may suitably alter their thrust to allow the robot 5 to swing back to a substantially vertically suspended position. Throughout operation of the robot 5, the propellers 48 generally maintain the robot 5 within a range of approximately 0 to 50 centimetres from the building 2 surface as required to allow operating the functional attachments and manoeuvre around obstacles.

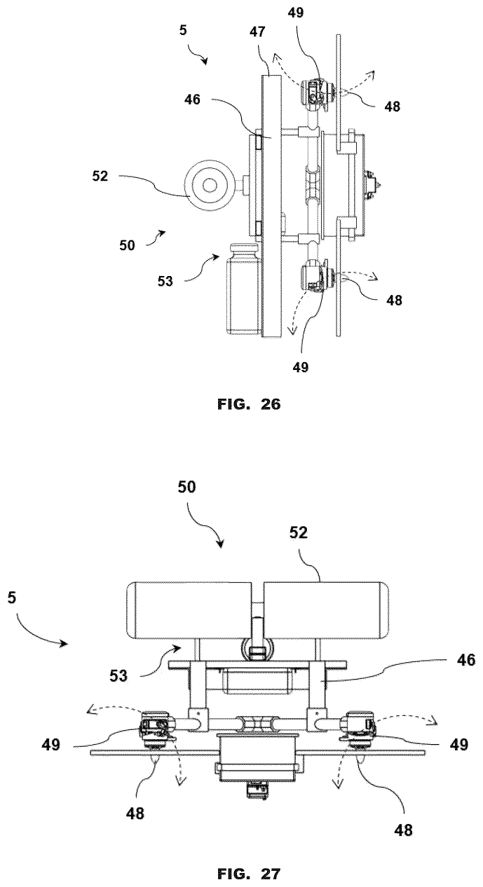

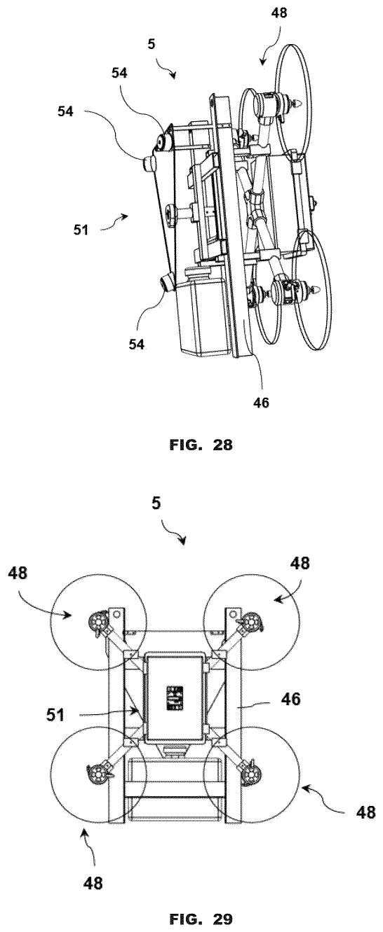

As best shown FIGS. 26 and 27, in some embodiments the propellers 48 of the robot 5 may be mounted to the frame 46 via gimbals 49 which allow the propellers to tilt up, down, left, and right in order to orient and direct a thrust direction of the propellers 48 to both stabilise the robot 5 during operation as well as manoeuvre the robot 5 about the external surface of a building 2. As will be outlined in detail below, in alternative embodiments, the gimbals 49 are configured such that the propellers 48 may only tilt laterally, that is, left and/or right. The orientation of each propeller 48 may be dynamically controlled to stabilise the system against various mechanical disturbances, such as wind, rain, and oscillations. Each gimbal 49 may be controlled independently and may thus orient each propeller 48 individually. The angle of the gimbals 49 may be controlled in response to positioning and movement information in order to counteract disturbances and provide a stabilising force. Whilst four propellers 48 are shown in the illustrated embodiments, in alternative embodiments, fewer or more propellers may be provided. Additionally, the robot 5 may include lateral propulsion system in the form of lateral jets to provide further selective lateral thrust for stabilising the robot. Such a lateral propulsion system may be configured specifically to counteract the lateral motion of the carriage. Alternatively, the propellers 48 may provide the lateral stabilisation.

The functional platform controller of the robot 5 is configured to control the robot 5 including operating the propulsion system and an attached utility module. The platform controller may include a transceiver for wirelessly sending and receiving signals, including controller signals and positioning information. The robot 5 may also include any of an inertial measurement unit (IMU), an accelerometer, a visual sensor, a proximity sensor, an ultrasonic sensor, and one or more propulsion sensors, for example, speed sensors on the propellers 48 configured to determine the displacement caused by the propulsion system based on the speed of the propeller and the corresponding thrust. The platform controller may implement a platform positioning system to receive positioning information from one or more of the sensors and fuse the positioning information from each of the sensors to estimate a unified position of the platform 5. The platform 5, controller, propulsion system and attachments may be powered by an on-board battery or by an external power supply.

In addition to the sensors and positioning systems of the carriage 4 and platform 5, one or more ‘lighthouse’ beacons or markers, or other positioning landmarks, may be placed about the external surface of the building, such as carried by the mounting arms 13, to facilitate positioning of the carriage 4 and/or platform 5 relative to the building 2. For example, on-board sensors of the carriage 4 and robot 5 may use position data inputs to determine an estimate of current position relative to the building facade. Detecting the landmarks may then assist in the position estimation, for example, the corners of the building may be used as a geodetic datum. The corners, or any suitable landmark, can be detected by the visual sensors of the carriage 4 and/or the robot 5 through shape matching and/or identifying a reflective ‘light house’, for example, in the form of a reflective material either permanently mounted to the building, or on the mounting arms 13.

In some embodiments, the robot 5 is a semiautonomous drone and the platform controller is configured to receive remote control commands from an external remote control. The remote control commands may direct and/or override the autonomous control. The platform controller is configured to operate as a primary controller, relaying commands to the carriage and receiving positioning of information from the carriage. In this way, the drone platform 5 is responsible for the unified positioning and drive control. Accordingly, the drone platform controller is responsible for taking the information from the various sensors and controller inputs and converting that to a command to send to the actuators and motors of the carriage 4 and robot 5. In alternative embodiments, the carriage controller of an external controller may be the primary controller.

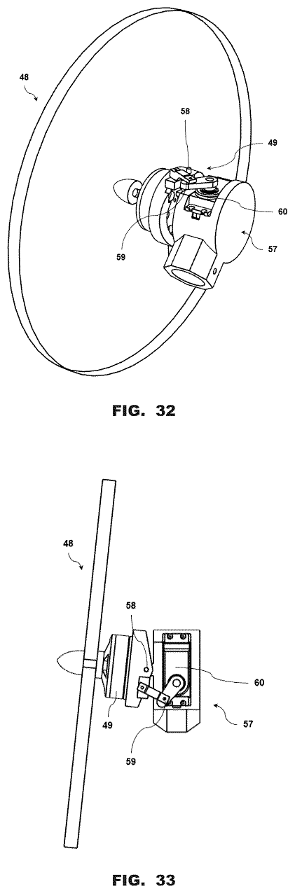

FIG. 32 shows a perspective view of one of the propellers 48 mounted to a propulsion mount 57 by a gimbal 49. In particular, the propeller is rotatably mounted to a propulsion axle in the form of a gimbal axle 58. A gimbal arm 59 is mounted to the propeller 48 and engaged with a gimbal motor 60. The gimbal motor 60 may drive the gimbal arm to articulate the propeller 48 about the gimbal axle 58. Referring to FIG. 33, the gimbal motor 60 may be used to control the angle of the gimbal 49 about the axis 58 thereby to direct the thrust of the propeller 48, for example, to position the robot and/or stabilise the robot by actively dampening oscillations. In alternative embodiments, a plurality of like gimbal axles; and respective gimbal arms and gimbal motors may be provided to enable the propeller to be articulated about a desired number of axles.

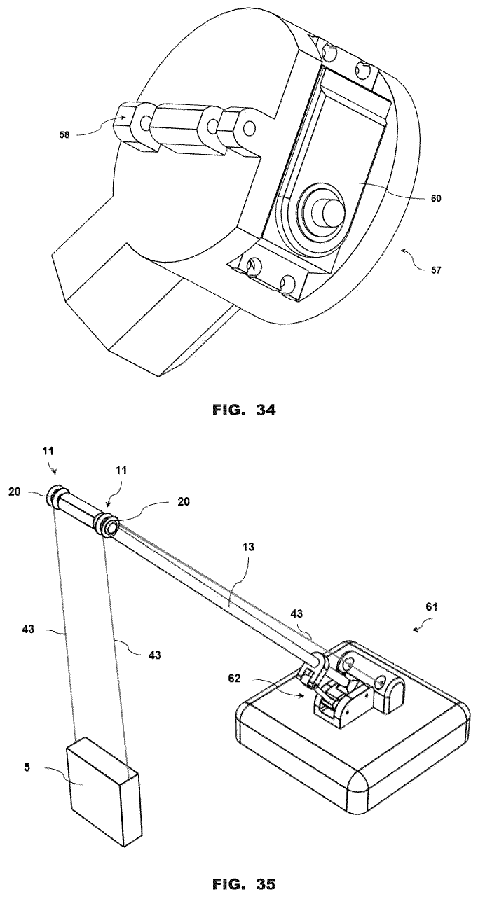

As best seen in FIG. 34, in one particularly preferred embodiment, the gimbal axle 58 is a vertical axle that, in use, locks the gimbal substantially parallel to the force of gravity such that the propeller 48 can only direct thrust laterally, orthogonal to the force of gravity. That is, the propeller is prevented from producing thrust that would support the weight of the robot 5 in the vertical plane. Advantageously, the propeller only producing lateral thrust prevents disturbances and oscillations in the vertical positioning and satisfies safety requirements for robotic propulsion systems.

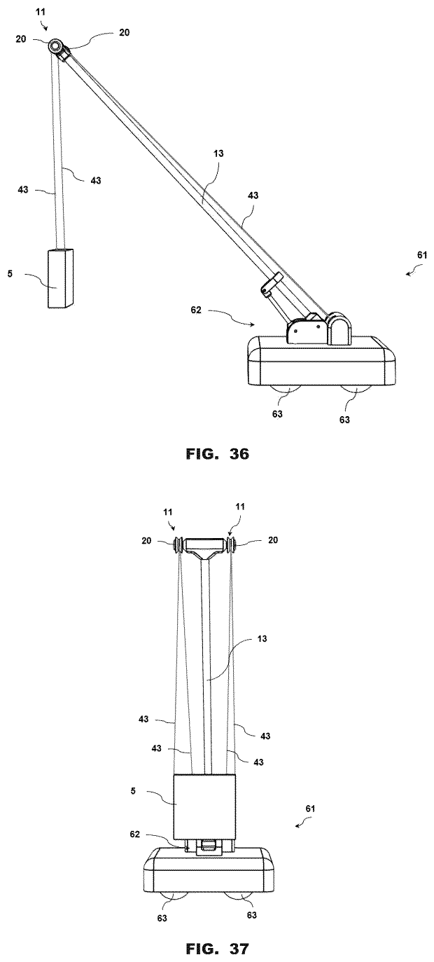

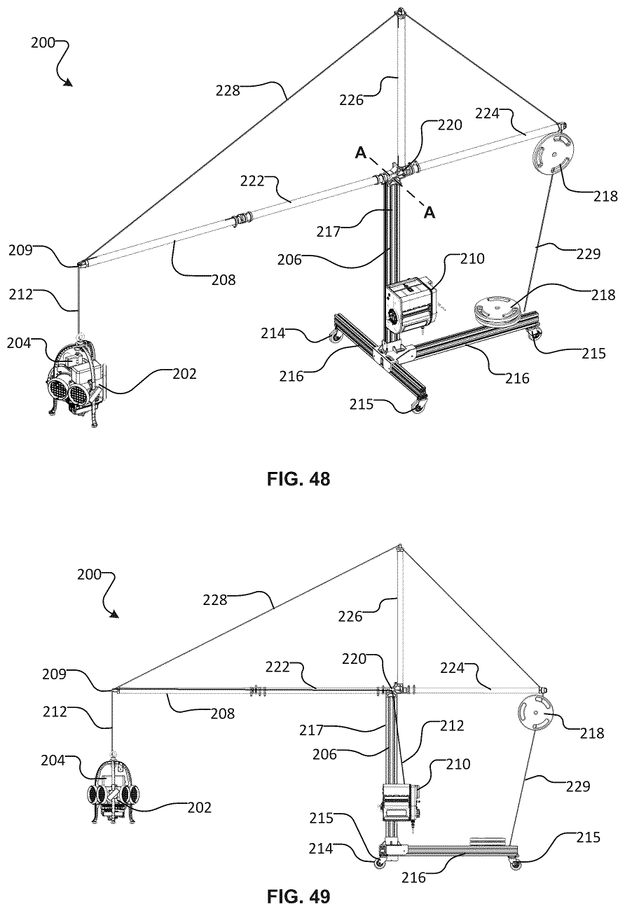

Referring to FIGS. 35 to 37, an alternative support system 90 for suspending a load 5 about the external envelope of a building is shown. Alternative embodiments 200, 230 of the support system 90, and components thereof, are shown in FIGS. 48 to 53 and described in greater detail below. The system 90 may include a moveable structure in the form of a trolley 61 with a crane member, in the form of a mounting arm 13, rotatably mounted to the trolley. The crane 13 and trolley 61 can be used to suspend the load 5 to facilitate one or more of window cleaning; façade cleaning; façade inspection, painting, signage installation; thermal monitoring; insect control; façade installation; façade repair; and other mechanical repairs. The mounting arm 13 may be configured for supporting a support member, in the form of a pair of suspension lines 43, from respective connection points 11. While a pair of suspension lines 43 are shown, it will be appreciated that the system 90 is configurable to have more, or less, lines 43, including only a single support line 43. The suspension lines 43 may extend from a winch mechanism in the trolley 61 via pulley arrangements 20 at the distal end 92 of the mounting arm 13 for suspending the load 92 from the suspension lines 43. The load 5 may be a functional platform, suspended scaffold and/or otherwise incorporate the modular suite of attachments as in the foregoing description. The trolley 61 may further include wheels 63 to manoeuvre about the surface of the roof. Alternatively or additionally the trolley 61 may utilise skids, or rails of a BMU to manoeuvre.

The trolley 61 may be wheeled about a top surface of the building and the mounting arm 13 rotated beyond the leading edge of the building to support the load 5 at an elevated position. Advantageously, the trolley 61 may be configured to travel over the entire top surface of the building, that is, the entire roof area. To use the crane and trolley system 90, the mounting arm 13 may be rotated to a substantially vertical set up position; a functional platform 5 may be suspended from the suspension lines 43; the trolley 61 may be wheeled to a desired location about the roof area of a building; and the mounting arm 13 may then be rotated to extend beyond the edge of the building, thereby enabling the platform 5 to be raised and/or lowered on the suspension lines 43. The trolley 61 includes a counter lever mechanism 62 for supporting the mounting arm 13 at the required angle. The trolley 61 can then be wheeled along the edge of the building to any position over the building roof. The payload 5 can be simultaneously raised and lowered via the suspension lines 43 thereby to allow access to all areas of the building façade. The control and support equipment for system operation are housed on the trolley 61 and positioned in such a way as to limit the number of additional counterweights required for suspending the desired payload over the façade.

The wheels 63 on the trolley 61 allow for both powered and unpowered omnidirectional motion. Advantageously, this allows for maximum manoeuvrability over the entire building envelope eliminating complex manoeuvres when navigating into tight situations. The trolley 61 is secured onto the building through a counterweight system whereby masses balance the mass of the suspended payload with sufficient Margin of Safety (MOS). The trolley 61 can also be integrated with existing BMU rails to allow a pre-determined path to be followed. Where no BMU rails exist, the trolley 61 can be controlled to move around the building with a remote control in addition to having a path planned and followed using methods including, pre-programmed routes, path/line following, light houses, and/or real-time route optimisation. In the case of a BMU rail being present, anchoring onto the rail is accomplished through use of a clamping mechanism.

The trolley 61 and crane 13 system is configured to be easily disassembled into separate sections. The crane mast 13 is also modular to be stowed in a compact volume. The carriage 61 may be made from high strength to weight ratio materials such as carbon fibre, fibreglass, and/or aluminium, along with a few small select parts having been made from high strength steels. Advantageously, the combined mass of the whole mounting system 90 may be constrained to below 30 kilograms. The compact nature of the trolley and crane system 90 allows the setup time and complexity to be dramatically reduced. All these features combined, enables the carriage to be lightweight and easily portable, from one building to the next.

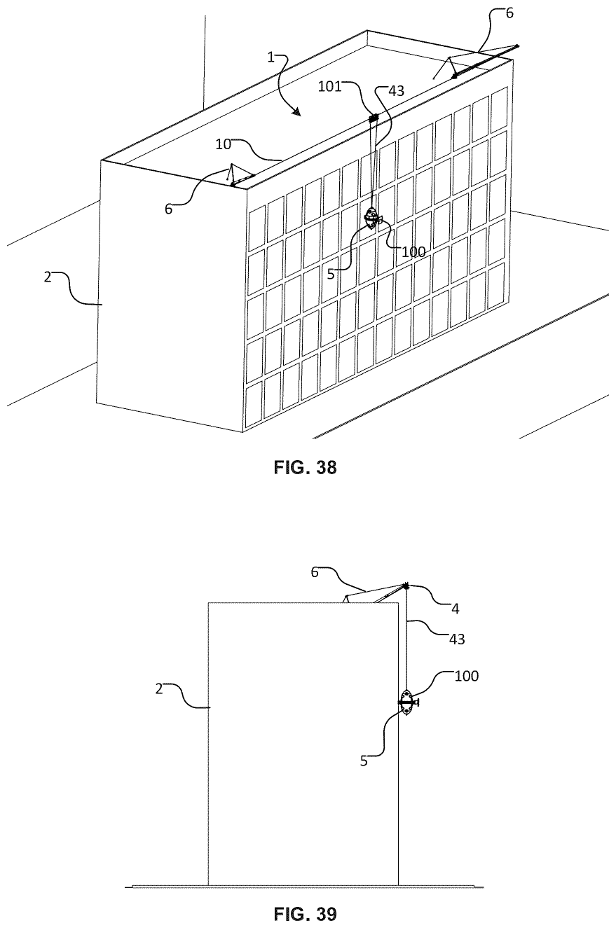

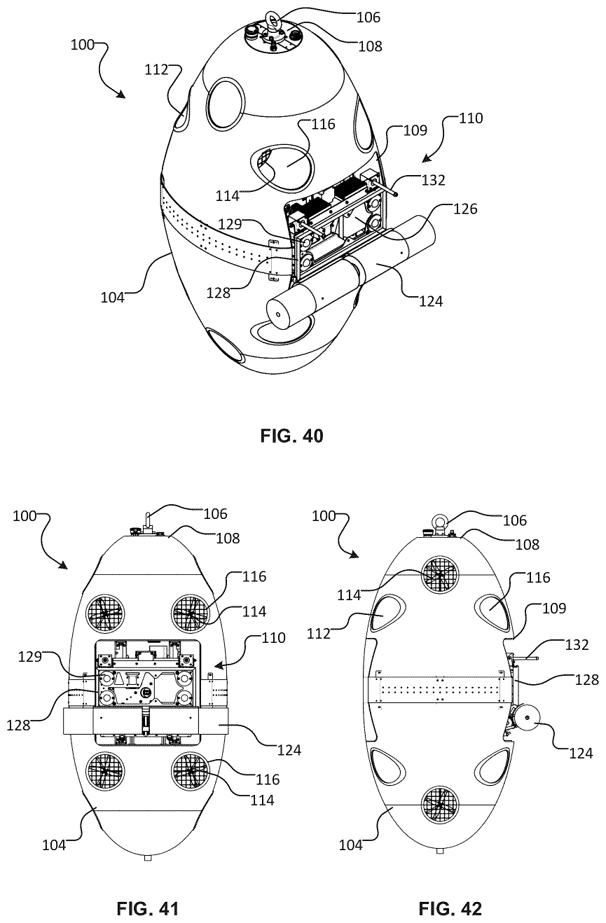

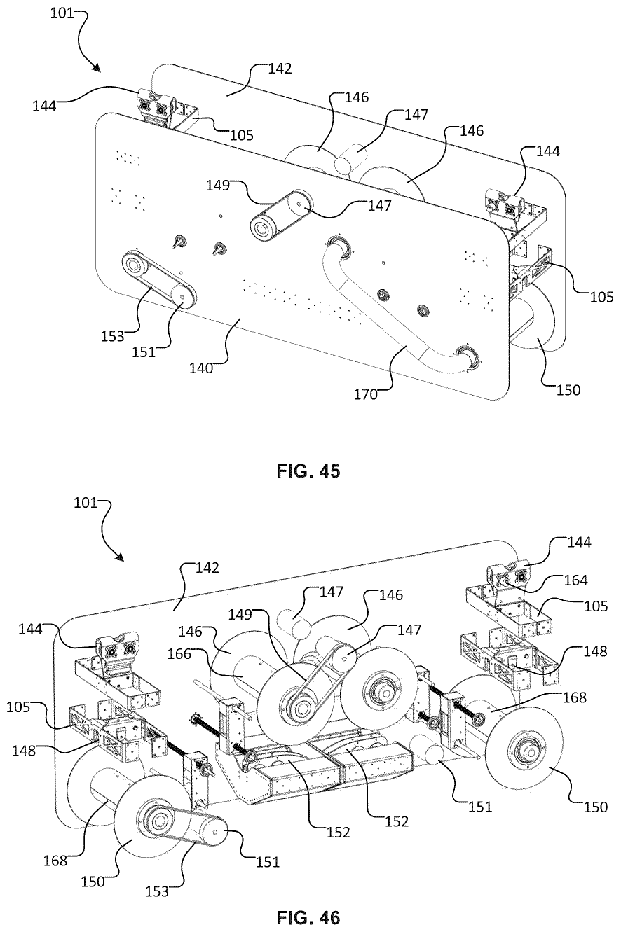

FIGS. 38 and 39 illustrate the system 1 installed on the building 2 with an alternative embodiment of the carriage 101 carrying an alternative embodiment of the functional platform 5, configured as a utility pod 100. FIGS. 40 to 44 show the utility pod 100 in isolation. FIGS. 45 to 46 show the carriage 101 in isolation.

The utility pod 100 is a functional platform for suspending from one or more suspension lines 43 to be at an elevated position relative to the building 2. The utility pod 100 includes a body 104 including a connector 106 arranged at an operatively top end 108 of the body 104 and configured to couple to the one or more lines 43, a utility module 110 arranged at one side 109 of the body 104, and a drive mechanism 112 operable to drive the pod 100 in at least one direction to allow urging the utility module 110 towards, or against, the building 2.

In the illustrated embodiment 100, the body 104 of the pod 100 is shaped to define smooth, typically double-curved, external surfaces to minimise resistance to moving air. This configuration can enhance stability of the pod 100 during use, when suspended from the carriage 4, as well as enhance durability by withstanding light impacts, such as may be caused by bouncing off the building 2 during use. It will be appreciated that the illustrated form of the external surfaces of the body 104 is exemplary and that the form may be configured according to use requirements.

The drive mechanism 112 typically includes one or more propulsion mechanisms 114 arranged at a side of the body 104 opposite to the side 109 of the utility module 110. Most typically, the drive mechanism 112 includes a plurality of the propulsion mechanisms 114 arranged about the body 104. In the illustrated embodiment, each mechanism 114 includes a powered rotor operable to generate thrust, and is arranged in a conduit 116 defined by, or attached to, the body 104 to provide ducted thrust in a single direction. The conduit 116 is shaped to be open at each end to allow air to be received at one end and exhausted at the other end, allowing each conduit 116 and associated propulsion mechanism 114 to act as a jet.

In the illustrated embodiment 100, each conduit 116 is fixed relative to the body 104. In other embodiments (not illustrated), one or more of the conduits 116 are rotatably mounted to the body about at least one axis to allow adjusting thrust direction. In some embodiments, the propulsion mechanisms 114 are arranged in pairs to be operable to generate thrust in opposed directions. This may involve arranging each mechanism 114 of a pair to be in a common conduit 116. In such embodiments, at least two of the propulsions mechanisms 114 are arranged opposite to each other in a first direction to generate thrust in an operative forwards direction and rearwards direction, and at least two of the propulsions mechanisms 114 are arranged opposite to each other in a second direction being orthogonal to the first direction to generate thrust in operative sideways directions. In yet other embodiments, each propulsion mechanism 114 is operable to generate thrust in two directions, such as by rotating the rotor in alternate directions.

Best shown in FIGS. 41 and 42, the body 104 carries four conduits 116 and associated propulsion mechanisms 114 arranged to exert a driving force in an operative forwards or rearwards direction, and two conduits 116 and associated propulsion mechanisms 114 arranged to exert a driving force in an operative sideways directions. This configuration allows reliably stabilising the position of the pod 100 relative to the building 2, such as to counteract wind or thermals, as well as manipulating the position of the pod 100 relative to the building 2, such as to avoid obstacles and/or enhance access, for example, under overhanging structures.

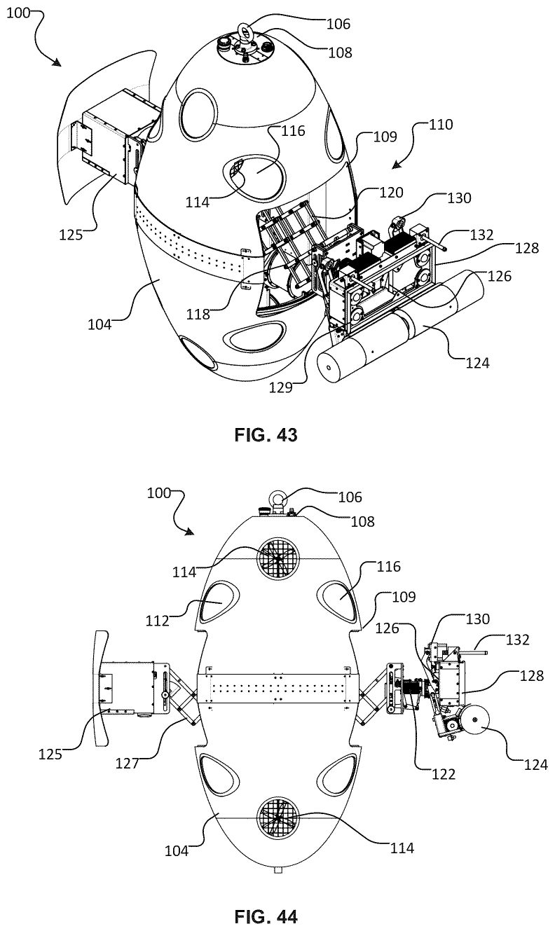

Best shown in FIGS. 43 and 44, the utility module 110 is mounted to a displacement mechanism 118 operable to displace the utility module 110 towards or away from the body 104. In this embodiment 100, the displacement mechanism 118 includes a scissor linkage 120 operable to displace the module 110 It will be appreciated that the linkage 120 structure is exemplary and that the displacement mechanism 118 may include other suitable structures, such as one or more controllably extendable gas struts. Operating the displacement mechanism 118 allows moving the utility module 110 relative to the body 104, for example, to adjust the extent of access to the building 2.

In some embodiments, the module 110 is rotatably mounted to the displacement mechanism 118 about at least one axis to allow adjusting orientation of the module 110 as well as position relative to the body 104 to further enhance the range of access. For example, in some embodiments, the displacement mechanism 118 includes a positioning mechanism, such as a wrist-type mechanism 122, operable to orientate the utility module 110, such as tilting the module 110 through 180 degrees, or greater, in an operatively side-to-side direction and/or upwards and downwards direction.

Best shown in FIG. 44, the displacement mechanism 118 includes a counterweight 125 mounted to a second scissor linkage 127 operable to displace the counterweight 125 relative to the body 104, typically in an opposite direction to the utility module 110 to mirror movement of the utility module 110. Again, it will be appreciated that the scissor linkage 127 is exemplary and that the pod 100 may be configured to include other suitable position adjustment mechanisms. Operating the displacement mechanism 118 in this way allows balancing the pod 100 to maintain position and orientation relative to the building during operation of the utility module 110.

The utility module 110 is usually configured to be releasably mounted to the displacement mechanism 118, or in some embodiments mountable directly to the body 104, to allow interchanging the module 110 for a different module 110. Each module 110 is typically configured for performing one or more specific tasks, or providing one or more specific functions, and therefore configuring the pod 100 to have a frame (body 104) for carrying any of a range of differently configured utility modules 110 allows the pod 100 to fulfil a wide range of different functions.

The utility module 110 is configurable to conduct at least one of generating a digital map of at least a portion of the geometry of the building 2; capturing one or more images of the building 2; measuring one or more physical parameters of the building 2; cleaning at least a portion of the building 2; repairing the building 2; and installing one or more objects on the building 2. For example, the system 1 may be supplied as a kit including a plurality of modules 110, where one module 110 is configured for cleaning, another module 110 is configured for surveying, and yet another module 110 is configured for manipulation or repairing. In some embodiments (not illustrated), the pod 100 may include a carousel carrying a plurality of utility modules 110 to allow changing between modules 100 during use of the pod 100 when suspended from the carriage 4. In such embodiments, the entire carousel of modules 110, or individual modules 110 arranged in the carousel, may be configured for rapid release from the body 106 to allow substituting other modules 110. Where the utility module 110 is configured to record or measure physical parameters to generate data, the module 110 is further configured to be communicatively coupled with a processor and/or memory, such as on-board the pod 100 or carriage 4, or by cellular or other wireless connection to a remotely hosted server.

Typically, each utility module 110 includes at least one or a tool and a sensor. In the illustrated embodiment 100, the utility module 110 is configured as a cleaning module which includes a powered, rotatable brush head 124 and suction mechanism 126 having an intake head 128 arranged adjacent the brush 124 so that operating the suction mechanism 128 draws the module 110 towards a surface, such as a wall or window, to enhance cleaning by the brush 124. In the illustrated embodiment, the intake head 128 carries a plurality of rollers 129 arranged to allow the head 128 to glide across a surface. The module 110 also includes one or more cameras 130 and probes 132 arranged to allow monitoring operation of the brush 124. In some embodiments, one or more of the probes 132 are connected to force sensors to allow measuring contact force exerted by the module 110 against the building 2.

In some embodiments, the intake head 128 houses at least one camera (not shown) and a light source (not shown), such as a strip of LED units, to form part of a dirt detection system operable to monitor and/or detect dirt on the building 2.

It will be appreciated that the configuration of the illustrated module 110 is exemplary and that the module 110 is alternatively configurable to include other tools and/or sensors. For example, in some embodiments (not illustrated), the module 110 includes a window seal integrity system (also known as a rain wand) communicatively coupled with a hose fed from a reservoir mounted on the building, the carriage 4 or the pod 100 and operable to direct a jet of fluid at the building 2 to test the seal of an aperture, such as about a window. This can be a requirement when completing constructions of a new building, or maintaining an existing building, which can be difficult to achieve by manual means.

In yet other embodiments (not illustrated), the module 110 carries a sensor array configured to measure a wide range of parameters. The array may include one or more cameras directed operatively upwards to allow imaging the roofline and/or the mounting arms 13 mounted at the top of the building 2. In such embodiments, this can enhance positional control of the carriage 4 and/or pod 100, particularly where lighthouse-type beacons are mounted on the building 2 and/or arms 13 as this can allow a position controller of the system 1 to triangulate position of the pod 100 relative to the beacons. It will be appreciated that the one or more cameras configured to detect beacons or landmarks in this way may instead be directly mounted to the body 104 to be a permanently affixed component of the pod 100.

FIG. 45 shows a first perspective view of the carriage 101 in isolation and FIG. 46 shows a second perspective view of the carriage 101 with a front housing 140 hidden to allow viewing internal components. The carriage 101 shares features with the previously described carriage 4, whereby common reference numerals indicate common features unless indicated otherwise. Whilst the carriage 101 is described with reference to the system 1 as shown in FIGS. 38 and 39, it will be appreciated that use of the carriage 101 is not limited to being a component of the system 1, and that the carriage 101 is applicable in other assemblies or systems to allow positioning a load. For example, the carriage 101 may be configured to be mounted to an elevated rail or track to carry a load across an alternative environment, such as a construction site or warehouse.

The carriage 101 includes a chassis 103, in this embodiment comprising the front housing 140 spaced from and fixed to an opposed rear housing 142. In the illustrated embodiment, the housings 140, 142 are shown as plates joined by brackets 105. It will be appreciated that in other embodiments (not illustrated), at least one housing 140, 142 may comprise a formed or moulded structure, such as pressed sheet metal, injection moulded plastic, or glass/carbon fibre shell. In such embodiments, the shape of the housing 140, 142 may be configured to optimise air flow around the housing 140, 142, such as to minimise interference by wind or thermals. In yet other embodiments (not illustrated), the chassis 103 is configurable as a framework, which can minimise weight of the carriage 101.

The housings 140, 142 define a plurality of mounting points for securing to the brackets 105 to carry the internal components between the housings 140, 142. Referring to FIG. 46, the internal components include a pair of support assemblies 144, a pair of lateral motion control mechanisms 146, a pair of load cells 148, a pair of vertical motion control mechanisms 150, and a pair of line feed mechanisms 152.

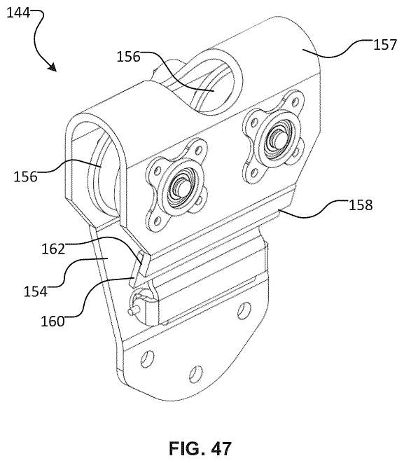

FIG. 47 shows a single support assembly 144 in isolation. Each assembly 144 is configured to releasably mount the carriage 101 to a support element, in this embodiment each assembly 144 being configured to receive and retain the zip line. The assembly 144 includes a body 154 configured to be mounted to one of the brackets 105 fixed between the housings 140, 142. The body 154 defines a receiving portion, in this embodiment being a hooked portion 157, to which a pair of rollers 156 are rotatably mounted. The body 154 further defines an opening 158 for receiving the zip line 10 and carries a latch 160 pivotally mounted adjacent the opening 158. The latch 160 is biased, such as by a torsion spring (not shown), towards an abutment surface 162 defined by the body 154 such that abutting the latch 160 against the surface 162 closes the opening 158. The arrangement of the latch 160 relative to the abutment surface 162 readily allows pivoting of the latch 160 away from the surface 162 to pass the zip line 10 through the opening 158 and against the rollers 156 so that the assembly 144 is carried on the zip line 10. Should the assembly 144 be vertically displaced relative to the zip line 10, such as caused by bouncing due to a collision of the carriage 101, or wind, the arrangement of the latch 160 causes it to be pressed against the abutment surface 162 by the zip line 10 to inhibit inadvertent removal of the zip line 10 from the assembly 144. Disassembly of the zip line 10 from the assembly 144 requires manually pivoting the latch 160 away from the abutment surface 162 to expose the opening 158.

Returning to FIG. 46, the support assemblies 144 are mounted to respective brackets 105 in alternate directions such that the opening 158 of one assembly 144 faces towards the front housing 140 and the opening 158 of the other assembly 144 faces towards the rear housing 142. This arrangement further inhibits inadvertent disconnection of the zip line 10 from the carriage 101 by requiring the zip line 10 to be inserted in a weaved arrangement, into opposed sides of the assemblies 144.

The support assemblies 144 are mounted between the housings 140, 142 to be spaced apart from each other at, or adjacent to, ends of the housings 140, 142, which can enhance stability of the carriage 101 on the zip line 10. At least one of the support assemblies 144 may include a rotary encoder 164 arranged to measure rotation of one of the rollers 156 to allow determining lateral position of the carriage 101 across the zip line 10 and/or relative to the support arms 13 or building 2.

The carriage 101 includes a pair of lateral motion control mechanisms 146 arranged to interact with one or more lateral drive lines to cause movement of the carriage 101 along the zip line 10. In the illustrated embodiment, each mechanism 146 is configured to carry a respective drive line (not illustrated) fixed to a spool 166 and be operable to wind the associated line about the spool 166. Each mechanism 146 is controllably driven by an electrically powered winch 147, in this embodiment via a connecting belt 149, to cause rotation of the spool 166.

The lateral control mechanisms 146 are configured for alternately directed operation such that operating the first mechanism 146 to cause winding the associated drive line around the associated spool 166 causes operation of the second mechanism 146 to unwind the associated drive line from the associated spool 166. Operating the mechanisms 146 in this way thereby allows effectively lengthening one drive line concurrent with effectively shortening the other drive line. When the free end of each drive line is connected to a fixed position, such as defined by the support arms 13 or the building 2, and the support assemblies 144 are mounted on a support member, such as the zip line 10, operation of the mechanisms 146 causes the carriage 101 to be drawn in the direction of the drive line being wound around the associated spool 166, thereby enabling lateral translation of the carriage 101 along the zip line 10.

Each lateral control mechanism 146 is associated with a load cell 148 mounted between the housings 140, 142 by one of the brackets 105 and arranged to receive one of the drive lines. The load cells 148 each comprise one or more rollers and are operable to measure force exerted along the associated drive line. Operation of the load cells 138 allows determining tension in the line to enhance controlling operation of the lateral control mechanisms 146. Typically, the load cells 148 are configured to communicate with the associated mechanism 146 to maintain tension at a defined value, or within a defined range. Operating a control loop in this way can prevent each drive line from sagging due to insufficient tension, and/or breaking due to excessive tension.

The carriage 101 also includes a pair of vertical motion control mechanisms 150 arranged to interact with one or more vertical drive lines to cause movement of a suspended load, such as the utility pod 100, towards or away from the carriage 101. In the illustrated embodiment, each mechanism 150 is configured to carry a respective drive line (not illustrated) fixed to a spool 168 and be operable to wind the associated line about the spool 168. Each mechanism 150 is controllably driven by an electrically powered winch 151, in this embodiment via a connecting belt 153, to cause rotation of the spool 168.

The vertical control mechanisms 150 are configured for correspondingly directed operation such that operating the first mechanism 150 to cause winding the associated drive line around the associated spool 168 causes operation of the second mechanism 146 to wind the associated drive line from the associated spool 168. Operating the mechanisms 150 in this way thereby allows effectively lengthening or shortening both drive lines simultaneously. When the free end of each drive line is connected to the load, such as the utility pod 100, and the support assemblies 144 are mounted on a support member, such as the zip line 10, operation of the mechanisms 146 causes the load to be drawn towards or away from the carriage 101, thereby enabling vertical translation of the load relative to the carriage 101.

Each vertical control mechanism 150 is associated with a line feed mechanism 152 mounted between the housings 140, 142 by one of the brackets 105 and arranged to receive one of the drive lines. Each line feed mechanism 152 houses one or more rollers (not shown) arranged to redirect the drive line from a substantially horizontal direction, received from the control mechanism 150, to a substantially vertical direction, towards the suspended load. The line feed mechanisms 152 are arranged adjacent each other and between the spaced vertical control mechanisms 150. This arrangement allows maintaining the suspended portion of each associated drive line in a substantially vertical direction, and substantially parallel to each other, which can minimise torque required by each control mechanism 150 to raise or lower the suspended load.

Whilst the carriage 101 is shown having a pair of lateral control mechanisms 146 and a pair of vertical control mechanism 150, it will be appreciated that in other embodiments (not illustrated), the carriage 101 is configurable to have more, or less, of each mechanism 146, 150, including having only a single lateral control mechanism 146 and a single vertical control mechanism 150. In such embodiments, only one drive line may be associated with the lateral control mechanism 146, and a separate only one drive line may be associated with the vertical control mechanism 150.

In some embodiments, the carriage 101 includes one or more utility lines (not illustrated) for operatively coupling the load suspended from the carriage 101 with another location to allow conveying fluid, electrical power, and/or data to the load. Typically each drive line is configured as a hollow structure containing the utility line. For example, the drive line may comprise a hollow Dyneema rope structure containing a polymer-shrouded core carrying the utility line. In some embodiments, the utility line is joined in parallel to the drive line.

Most typically, the utility line is wound around the spool 166 of one of the lateral control mechanisms 146, coaxially within, or adjacent, the drive line, and into a cavity 169 defined by the spool 166, The utility line then extends out of an end of the spool 166 to travel through a conduit 170 mounted to one of the housings 140, 142 to enter a cavity defined by the spool 168 of one of the vertical control mechanisms 150. The utility line is then wound around the spool 168 coaxially within, or adjacent, the drive line, and along the drive line to the suspended load.

In the illustrated embodiment, a pair of utility lines are provided where a first utility line is fed from the left-hand-side lateral control mechanism 146 to the left-hand-side vertical control mechanism 150, and to the pod 100, and a second utility line is fed from the right-hand-side lateral control mechanism 146 to the right-hand-side vertical control mechanism 150, and to the pod 100. The first line is configured to convey fluid, typically being water and/or detergent, from a remote fluid supply, such as a roof-mounted reservoir, to the pod 100. The second line is configured to convey electrical power and data from a remote connection to the pod 100. Installation of the system 1 to the building 2 to allow the functional platform 5 to access the external envelope of a building 2 involves mounting each of the pair of support assemblies 6 at a top of the building 2 to be spaced apart from each other, and securing the zip line 10 between a fixed position, such as defined at the end 11 of base of the support member 13, against the free end 11 of each support member 13, and to the retraction mechanism. The retraction mechanism is then operated to causes the zip line 10 to tension between the support members 13. The carriage 4 is connected to the functional platform 5 and mounted on the zip line 10. The support members 13 are rotated about the respective position axes 7 to arrange the zip line 10 above the top of the building 2. The platform 5 may then be lowered from the carriage 4 to be at an elevated position relative to the building 2. The platform 5 is then operable to perform one or more tasks, or provide one or more functions, with respect to the external surfaces of the building 2.

Installation of the system 1 typically involves fixing a base plate 14, back support anchor 16 and at least one tension anchor 17 adjacent to two, or more, corners defined by the top of the building 2. The base plate 14 and anchors 16, 17 are typically bolted to the top surface of the building 2 and intended to remain as substantially permanent installations on the building 2. The base plate 14 and back support anchor 16 may be installed equidistantly from adjacent edges at each corner and a pair of the tension anchors 17 may be installed corresponding to each adjacent edge. Advantageously, only the base plate 14 and anchors 16, 17 are permanently installed with the remaining equipment of the system 1 able to be transported between buildings 2.

In some embodiments, the system 1 is specified to weigh approximately 55 kg where each mounting arm 13 and associated lines are approximately 20 kg, the carriage 4 is approximately 10 kg, and the robot 5 and attachments are approximately 5 kg. In other embodiments, such as illustrated in FIG. 38, the system 1 is specified to weigh around 80 kg, where the carriage 4 weighs approximately 20 kg, the platform 100 weighs approximately 40 kg, and the mounting arms 13 and associated lines are approximately 20 kg. Because the system 1 is primarily formed from lightweight aluminium components and can be substantially disassembled, it is possible for one or more persons to manually transport the system 1 between buildings, with some embodiments requiring a trolley assist transporting the system 1. The modular nature of the functional platform 5 and respective attachments in conjunction with the portability of the system 1 enable convenient monitoring and maintenance of multiple buildings.

To set up the system 1 for use, each mounting arm 13 is assembled by joining the requisite number of pole sections 25 by respective collars 15. Each mounting arm 13 is coupled to a respective coupling 15 and the coupling 15 is rotatably mounted to a respective base plate 14. The mounting arms 13 and couplings 15 are removably rotatably mountable to the respective base plates 14 by way of the removable mounting axle 28, for example, as shown in FIG. 14. A back support arm 22 is rotatably mounted to each coupling 15 and a static upper support line 21 connected between the distal end of the respective back support arm 22 and the distal end of the corresponding mounting arm 13. The length of the upper support line 21 is selected such that the back support arm 22 is at generally right angles to the respective mounting arm 13. A lower support line 23, which is typically associated with a ratcheting portion, is connected between each back support arm 22 and corresponding back support anchor 16. Initially, the lower support line 23 is arranged to be slack to allow the mounting arms 13 to rotate freely about the position axis 7 during set up.

Each mounting arm 13 is laid inwardly, away from the periphery of the building 2, and towards the other mounting arm 13. A static zip line 10 may be mounted across the end 11 of each arm 13, typically being threaded through the pulley end cap 20 of each mounting arm 13 and tied off at the tie down point 31 on the respective pivot assemblies 15. The length of the zip line 10 may be selected according to the length of the edge 8 and the respective dimensions of the mounting arms 13, such that, the system 1 may suitably tension the zip line 10 beyond the edge 8. In other applications, a length-adjustable zip line 10 is mounted across the end 11 of each arm and to an adjustment mechanism, such as a ratchet mechanism, operable to adjust the effective length of the zip line 10. The zip line 10 may be a single line or include a separate drive line and guide line. The untensioned drive line is threaded around the drive wheel of the carriage 4, and the guide wheels of the carriage 4 are engaged with the untensioned guide line.

A tension line 19 is connected between the distal end 11 of each mounting arm 13 and the corresponding tension anchor 17. Each mounting arm 13 is then rotated towards the edge 8, just forward of a substantially vertical position, sufficient to take the slack out of the back support lines 18 and to tension the zip line 10 sufficiently to lift the zip line 10 and carriage 4 off the building 2. A stop bar 24 in each base plate 14 may optionally be used to maintain each mounting arm 13 at a substantially vertical position. A functional platform 5, in the form of the robot 5 or the pod 100, including the desired utility module is connected to suspension lines 43 of the carriage 4. The set-up of the mounting arms 13, zip line 10, carriage 4 and robot 5 may be performed away from the edge 8 of the building 2 to distance the user from the edge 8, which can reduce the risk of fall related injuries.

Where the tension lines 19 include, or are associated with, ratchet portions, these are then operated to ratchet the tension lines 19 and rotate the arm 13 about the tension axis 9 to space the distal end 11 of each mounting arm 13 apart and consequently arrange the arms 13 to diverge away from each other, thereby to tension the zip line 10 in a tension plane. Accordingly, the forces of the tensioned zip line 10 and the respective tension lines 19 are redirected to compressively load the mounting arms 13. This effect may be enhanced by each tension anchor 17 being arranged to be inward from the distal end 11 of the respective mounting arm 13 towards the respective base plate 14. The redirection of forces along the length of the two mounting arms 13 at either side of the building 2 and towards the mounts 14 allows the system 1 to be in purely tensile loading. Advantageously, this can minimise the required support structure and allows the system to leverage ultra-lightweight tensile loading materials for the majority of the components. This can mean that time required to set-up the system 1, as well as total system mass and material cost, can be minimised. Furthermore, the Margin of Safety (MOS) may be higher than a conventional mounting structure of similar size and mass.

The effective length of the back support lines 23 may now be adjusted, such as by operating an associated ratchet mechanism, to a desired length corresponding to a desired position of the mounting arms 13 about the position axis 7, consequently adjusting the position of the zip line 10 relative to the building 2. During this operation, the pair of mounting arms 13 are rotated forwards about the position axes 7 towards the edge 8 of the building 2. The zip line 10, including the carriage 4 and robot 5, is brought beyond the edge 8 of the building 2. The back support ropes 18 then support the mounting arms 13 and the zip line 10 tensioned therebetween at the desired position beyond the edge 8 of the building 2.

The arrangement of the mounts 14 to define a common position axis 7, and rotatably mounting of the arms 13 about this axis 7, mean that the zip line 10 may be tensioned in a plane that can rotate about the position axis 7. Due to the in-plane tensioning of the zip line 10, the support assemblies 6 can be stabilised at any desired deployment angle about the axis 7. Accordingly, moving one mounting arm 13 about the axis causes the other mounting arm 13 to be pulled to the same angular position. This in-plane tension enables the tensioning of the zip line 10 and mounting of the carriage 4 and robot 5 at a convenient position on the surface of the roof and subsequently allows the tensioned zip line 10 to be repositioned by rotating about the common position axis 7. Thus, the system may support the tensioned zip line 10 above and beyond the edge 8 of the building 2, including where a barrier or rail 12 surrounds the edge of the building 2. The respective dimensions of the mounting arms 13 and base plate 14 may be configured as necessary to extend above and beyond any such barriers 12. Advantageously, the mounting arms 13 may be rotated to any required position angle based on the specific geometric limitations of different buildings, enabling flexibility across installations.

With the tensioned zip line 10 supported beyond and above the edge 8 of the building 2, the carriage 4 is able to move laterally along the zip line 10 and is able to raise and lower the platform 5 to access across the face of the building 2. During this operation, where the zip line 19 includes separate guide line and drive line, the guide line supports the carriage 4 and platform 5, while the drive wheel is operable to pull the carriage 4 and platform 5 along the drive line to a desired lateral position. The carriage 4 is operable to raise and/or lower the platform 5 to a desired vertical position via the motorised winches of the suspension wheels. The independently operable drive and suspension wheels can enable the carriage 4 to raise/and or lower the robot 5 as well as move along the length of the zip line 10 simultaneously. The robot 5 may thus be operated to clean, monitor and otherwise perform functions as desired about the face of the building 2.

Referring to FIG. 31, there is illustrated an example façade cleaning path 55. The system 1 may be programmed to convey the platform 5 along this path by moving the carriage 4 along the zip line 10, as well as operating the platform 5 to clean the facade. The platform 5 is moved along the small ‘N’ shapes, as well as along the larger ‘Z’ shape. This path generally coincides with common configurations of external facing windows of buildings. It will be appreciated that the system 1 is configurable to drive the carriage 4 and platform 5 along alternative paths where necessary to access specific geometry defined by a building.

FIG. 31 also illustrates an example façade inspection path 56. The system 1 may be programmed to convey the platform 5 along this path by moving the carriage 4 along the zip line 10, as well as operating the platform 5 to inspect the facade. In the illustrated cleaning path 55 and inspection path 56, the platform 5 is able to traverse to virtually any point on the face of the building 2. Due to the Cartesian nature of the carriage's and robot's combined lateral and vertical motion, the system 1 can provide access to the whole face of the building 2.

During operation of the robot 5 or pod 100 for cleaning, monitoring or other functions, the propulsion systems 48, 114 are operated to provide a contact force to push the robot 54 or pod 100 against the building 2 envelope. This can allow, for example, the robot 5 or pod 100 to firmly press against the surface of the building 2, such as to enhance efficacy of brushing to remove particles or residue. The propellers 48 of the robot 5 may also articulate on their respective gimbals 49 to provide respective thrust forces to stabilise the system from wind and other disturbances. Furthermore, the propulsion systems 48, 114 may be operated to manoeuvre the robot 5 or pod 100 about the building envelope to avoid obstacles, for example, mullions around windows, faced protrusions, or air conditioning and other plant equipment and ducts.

Once the cleaning and/or monitoring operations in respect of the first face of the building 2 have been completed, the platform 5 is retracted back up to the carriage 4 and the mounting arms 13 are rotated about the position axis 7 to bring the zip line 10 away from the 8 edge of the building 2. The zip line 10 is then untensioned and the mounting arms 13 removed from the base plates 14. The mounting arms 13 may then be rotatably mounted at the adjacent corners of another edge of the building 2 and any of the above described process steps repeated to allow, for example, cleaning or inspecting another face of the building 2. Once the cleaning and/or monitoring operations in respect of all desired faces of the building 2 have been completed, the mounting arms 13, lines 10, 18, 19, carriage 4 and robot 5 may be disassembled and transported to another building. Advantageously, a single set of equipment may be conveniently transported to service multiple buildings, proving substantially more cost effective than installing and operating permanently installed systems at each building.

It will be appreciated that the illustrated embodiments can provide a building envelope access system 1 which is lightweight, portable, and/or which can provide access to the entire wall or external surfaces of the building 2 to perform a variety of monitoring, maintaining and other functions via a modular platform 5.

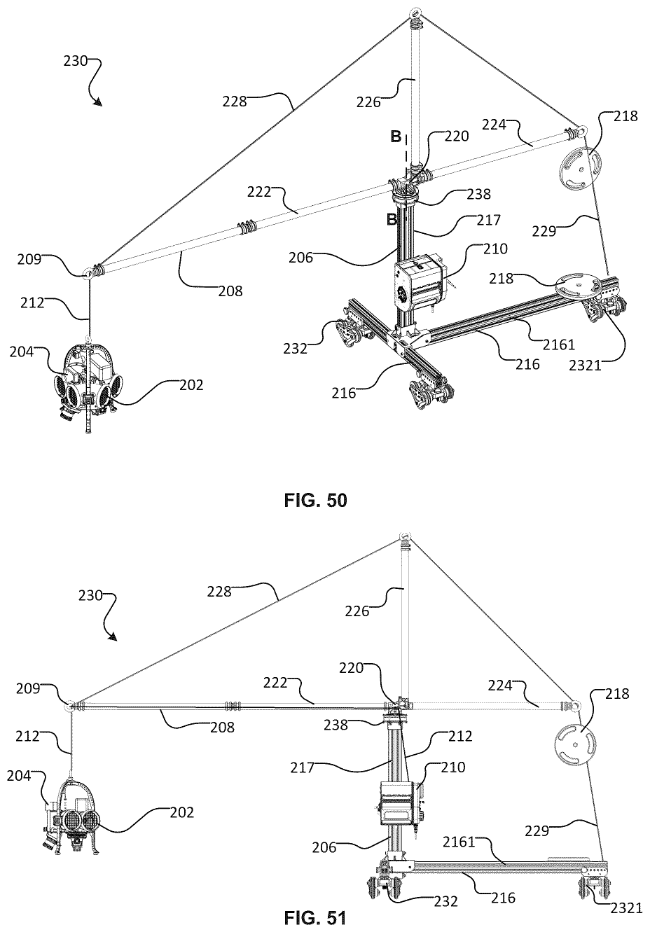

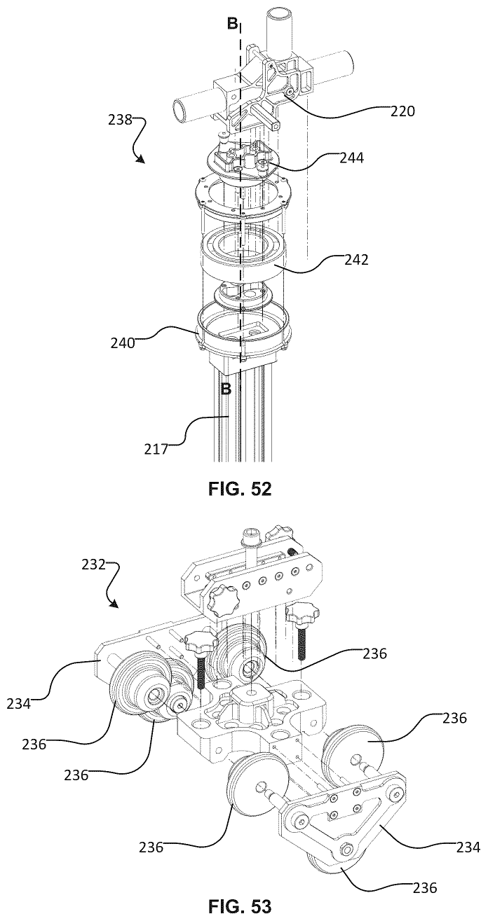

FIGS. 48 to 53 illustrate alternative embodiments 200, 230 of the system 90 described above. It will be appreciated that common reference numerals indicate common features unless indicated otherwise. FIGS. 48 and 49 illustrate a first alternative system 200 for positioning a functional platform 202, including an imaging system 204, at an elevated position relative to external walls of a building to facilitate façade inspection. FIGS. 50 and 51 illustrate a second alternative system 230 for positioning the functional platform 202 at the elevated position. FIGS. 52 and 53 illustrate components of either system 200, 230, being a vertical axis pivot mechanism 238 (FIG. 52), and a wheeled bogie mechanism 232 (FIG. 53).

The system 200 includes a manually portable trolley 206 configured to be movable across a roof of the building, and carrying a crane member 208 having a distal end 209. a winch mechanism 210 mounted to the trolley 206, and a suspension line 212 extending between the functional platform 202 and the winch mechanism 210. The system 200 is configured to that, in use, the trolley 206 is positioned on the roof of the building so that the distal end 209 is arranged beyond a leading edge of the building to suspend the functional platform 202 at the elevated position, the trolley 206 is movable across the roof, and the functional platform 202 is raised and lowered via the suspension line 212 to allow access across the building façade.

The imaging system 204 may include one or more cameras and/or sensors, as described above. Generally, the system 204 includes at least one optical camera, a thermal (infrared) imaging camera, and a lamp. In some embodiments, the system 204 additionally or alternatively includes a spectroscopy (ultraviolet) imaging camera. It will be appreciated that the imaging system 204 may be adapted according to the requirements of the system 200, such as the type of façade being inspected, and data required by the user, and therefore may include a range of other imaging components.

The trolley 206 may be configured to carry a plurality of wheels 214 to enable movement of the trolley 206 across a surface, such as the roof. In this embodiment, the wheels 214 are configured as castor wheel mechanisms 215 to enhance ease of rotational and linear motion relative to the surface. It will be appreciated that, in other embodiments, such as shown in FIGS. 35 to 37, the wheels 214 may be alternatively configured, such as the omnidirectional wheels 63 of the system 90. The trolley 206 is typically configured to be manually moved across the surface, such as by a user pushing the trolley 206 or crane member 208. In some embodiments (not illustrated), the trolley 206 may also carry a drive mechanism, such as an electric motor, to assist or drive movement of the trolley 206.

The castor wheel mechanisms 215 are arranged on a common plane at vertices of a notional triangle. The vertices are defined by first members 216 coupled together to form a base portion of the trolley 216. The arrangement of the wheels 214 about the notional triangle may enhance stability of the troller 206. In this embodiment, the members 216 form a T-shaped structure. Best shown in FIG. 49, the T-shaped structure is arrangeable to extend away from the distal end 209 of the crane member 208 to form a cantilever structure to counteract the weight of the platform 202 carried by the crane member 208. Counterweights 218 may be mounted to the base portion and/or operatively rear end of the crane member 208, as shown in FIG. 48, to enhance counteracting force exerted on the crane member 208 during use.

The trolley 206 also includes a second member 217 arranged to extend perpendicular to the base portion to form a mast. In the illustrated embodiment, the winch mechanism 210 is mountable on the mast. In other embodiments (not illustrated), the winch mechanism 210 may be carried by one of the first members 216 or the crane member 208, for example, in place of the counterweight 218. In the illustrated embodiment 200, each of the first members 216 and second member 217 are formed from extrusions. It will be appreciated that other forms are within the scope of this disclosure, such as tubular elements.

Best shown in FIG. 49, when mounted to the trolley 206, the winch mechanism 210 is connected to the suspension line 212. The line 212 may be arranged across a bearing structure, such as pulley wheels, mounted on or defined by the crane member 208 such that operation of the winch mechanism 210 adjusts the effective length of the line 212 to lower or raise the platform 202 relative to the crane member 208.

The crane member 208 is typically releasably mounted to the mast via a pivot mechanism 220. In this embodiment, the pivot mechanism 220 defines an operatively horizontal axis, labelled A-A, to allow pivoting the distal end of the crane member 208 towards or away from the base portion of the trolley 206. The pivot mechanism 220 is configurable to be rotatably locked at one or more defined positions about the axis to inhibit pivoting of the crane member 208 relative to the trolley 206. Typically, the mechanism 220 is lockable at 60 degree increments, for example, to assist set up of the system 200.

In the illustrated embodiment, the crane member 208 comprises a plurality of interconnected struts, including a jib 222 defining the distal end 209, a counterjib 224 extending in an opposite direction to the jib 222, and a jib strut 226 extending substantially perpendicular to the jib 222. One or more tension members, in this embodiment in the form of cables 228, are connected between the jib 222, the jib strut 226, and the counterjib 224. A single cable 228 may be connected across all of the struts 222, 224, 226, or separate cables 228 connected between adjacent struts 222, 224, 226. In either scenario, each cable 228 is tensioned to enhance rigidity of the crane member 208. Also, as shown in FIGS. 48 and 49, a further tension member 229 may be connected between the counterjib 224 and the trolley 206. This may be arranged to limit tilting of the distal end 209 of the jib 222 about the axis A-A.

The trolley 206 and crane member 208 are configured to be disassembled from each other to enhance ease of transport between buildings, and/or assembly of the system 200 on the roof of the building. In some embodiments, the system 200 is configured to be modular to allow being stowed in a compact volume. In such embodiments, the trolley 206 and/or crane member 208 is configurable to be readily disassembled into discrete sections. For example, the trolley 206 is configurable such that the first members 216 and the second member 218 are readily decoupled from each other, and/or the crane member 208 is configurable such that the struts 222, 224, 226 are readily decoupled from each other. Furthermore, at least the jib 222 may be formed from a plurality of releasably connected, or telescopic, sections, such as tubular members, to allow further disassembly. In the illustrated embodiment, the jib 222 comprises two sections. It will be appreciated that the jib 222 may comprise more, or less, sections to adjust the length of the jib 22, for example, should the platform 202 need to be spaced further from the building to enable façade inspection. Such modular embodiments may allow the trolley 206 and crane member 208 to be packed down into a bag, such as a backpack, to enhance manually carrying the system 200 between buildings and/or about the roof of the building, for example, up and down ladders or stairs.

FIGS. 50 and 51 show the system 230 which includes the trolley 206 and crane member 208 as described above. In this embodiment 230, the trolley 206 is modified to allow cooperating with conventional BMU rails affixed to a roof of a building. Modification involves supplementing or, as illustrated, replacing the castor wheel mechanisms 215 with at least a pair of rail engagement mechanisms 232 to allow engaging the spaced, parallel BMU rails. In this embodiment 230, three rail engagement mechanisms 232 are releasably mounted to the first members 216 to arrange the mechanisms 232 on the common plane and at vertices of the notional triangle. At least one of the mechanisms 232 may be slidably mounted to the respective first member 216 to allow adjusting relative positions of the mechanisms 232. In this embodiment, the rear mechanism 2321 is slidably mounted to the rear first member 2161 to allow selectively adjusting spacing of the mechanisms 232. This can allow mounting the trolley 206 to a range of different BMU rails.

Best shown in FIG. 53, each rail engagement mechanism 232 may be configured to include a bogie frame 234 carrying a plurality of wheels 236. The wheels 236 are rotatably mounted to the frame 234 to allow carrying the frame 234 along the BMU rail. In this embodiment, the frame 234 carries six wheels 236, with four wheels 236 arranged to be placed against one side of a BMU rail, and two wheels 236 arranged to be placed against the other side of the BMU rail, thereby trapping the rail between the wheels 236. It will be appreciated that the frame 234 may be alternatively configured to carry more, or less, wheels 236, depending on its application, such as only a pair of wheels 236 arrangeable on one side of the rail, and a single, spaced wheel 236 arrangeable on the opposed side of the rail. In some embodiments, the wheels 236 are releasably mountable to the frame 234 to allow substituting differently sized/shaped wheels to suit the BMU rail geometry.

Typically, each rail engagement mechanism 232 is rotatably mounted to the base portion of the trolley 206. This arrangement allows the trolley 206 to track along a curved rail, for example.

In some embodiments, the trolley 206 may include a drive mechanism (not illustrated) configured to be associated with one of rail engagement mechanisms 232 and operable to drive the mechanism 232 along the rail. In such embodiments, the system 230 may also include a controller module (not illustrated) communicatively coupled with one or more of the winch mechanism 210, the imaging system 204, and the drive mechanism, and operable to control operation of any of the winch module 210, the imaging system 204, and the drive mechanism. In some embodiments, the controller may be configured for autonomous operation, for example, to self-guide the trolley 206 along the rails, as well as moving the platform 202 relative to the façade while imaging the façade with the imaging system 204.

In this embodiment 230, the crane member 208 is mounted to the trolley 206 via an alternative pivot mechanism 238 defining an operatively vertical axis, labelled B-B. Pivoting the crane member 208 about the axis B-B causes lateral rotation of the distal end 209 relative to the trolley 206. This mechanism 238 may be useful to adjust the position of the suspended platform 202 relative to the façade, and/or maintain a consistent separation distance of platform 202 from the façade as the trolley 206 is moved around a corner, or along a curved rail. Either approach may be useful to assist imaging by the imaging system 204, for example, to maintain or adjust a focal length.

The pivot mechanism 238 is shown in an exploded view in FIG. 52. This shows the mechanism 238 may include the horizontal axis mechanism 220 to enable pivoting of the crane member 208 relative to the trolley 208 about two axes. The vertical axis B-B is provided by a first housing 240 being mounted to the mast of the trolley 206, and a bearing mechanism 242 being received in the first housing 240. The crane member 208 is mounted to a second housing 244 carried by the bearing mechanism 242 to allow relative rotation of the housings 240, 244.

Either of the systems 200, 230 may be configured as a manually portable modular kit for facilitating façade inspection of a building. When configured in this way, the kit may comprise: a trolley comprising a base module configured for movement across a roof of a building, such as formed from the first and second members 216, 218, and a releasably mountable jib module, such as formed from the struts 222, 224, 226; an imaging module 204 associated with one or more propulsion mechanisms, such as the ducted mechanisms 114 described above, operable to stabilise the module 204 relative to the building; a cable 212 connectable to the imaging module 204; and a winch module 210 releasably mountable on the trolley and having a spool, the winch module 210 engageable with the cable 212 and operable to wind the cable 212 around the spool.

In such embodiments, each module is typically dimensioned and specified to allow being manually carried between buildings, and transported to the roof via a conventional elevator. This allows the modular system to be readily installed on a roof, operated to inspect the façade, and then disassembled to allow being deployed on a different roof.

The modular kit may be used for inspecting a façade of a building by executing the following steps: mounting the jib module to the base module; mounting the winch module 210 to the trolley; securing the cable 212 between the imaging module 204 and the winch module 210; positioning the trolley on a roof of the building so that an end of the jib module is spaced outwardly from the building to suspend the imaging module 204 in an elevated position adjacent the building; operating the winch module 210 to lower and/or raise the imaging module 204, and/or moving the trolley along one or more paths about a peripheral region of the roof, concurrent with operating the imaging module 204 to capture images of the façade and operate the propulsion mechanism(s) to stabilise the module 204 relative to the façade.

The modular kit may include a plurality of motion control modules, such as the castor mechanisms 215 or the wheeled bogey mechanisms 232, releasably mountable to the base module to facilitate the relative movement of the trolley and the roof of the building. Where the kit includes motion control modules configured for rail mounting, use may involve engaging the modules with a BMU rail on the roof of the building.

Operating the assembled modular kit may also involve successively repeating the steps of moving the trolley along the one or more paths, and operating the winch mechanism 210, to cause the imaging module 204 to successively traverse laterally, and vertically, across the façade. An example of an inspection path 56 defined by successive lateral and vertical motions of the imaging module 204, caused by movement of the trolley and operation of the winch 210, is shown in FIG. 31.

It will be appreciated that the kit may be operated to displace the imaging module 204 along any combination of lateral and vertical motions relative to the façade. For example, for some applications, the winch mechanism 210 is operated to unwind the cable 212 to cause the imaging module 204 to descend across the façade, for example, from roof level to ground level, concurrent with operating the module 204 to image the façade, the trolley then moved across the roof, and the winch mechanism 210 again operated to wind the cable 212 to cause the imaging module 204 to ascend across the façade, for example, back up to roof level.

Use of either of the systems 200, 230 for inspecting a façade of a building generally involves: positioning the trolley 206 on the roof, or other elevated/top surface, of the building; securing the suspension line between the platform 202 and the winch mechanism 210; arranging the trolley 206 so that the distal end 209 is arranged beyond a leading edge of the building to suspend the platform 202 at the elevated position; operating the winch mechanism 210 to displace the platform 202 relative to the façade, and/or moving the trolley 206 at least partly about a periphery of the roof/top surface, concurrent with operating the imaging system 204 to image the façade. As described above, operating the winch mechanism 210, and moving the trolley about the roof 206, may be repeated to allow imaging across a portion, or the entirety, of the façade.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

The specification can be readily understood with reference to the following Numbered Paragraphs:

Numbered Paragraph 1. A system for positioning a functional platform including an imaging system at an elevated position relative to external walls of a building to facilitate façade inspection, the system including:
a manually portable trolley configured to be movable across a roof of the building, and carrying a crane member having a distal end, the trolley and crane member configured to be disassembled;
a winch mechanism mounted to the trolley; and
a suspension line extending between the functional platform and the winch mechanism,
whereby, in use, the trolley is positioned on the roof of the building so that the distal end is arranged beyond a leading edge of the building to suspend the functional platform at the elevated position, and is movable across the roof, and the functional platform is raised and lowered via the suspension line to allow access across the building facade.

Numbered Paragraph 2. The system of Numbered Paragraph 1, wherein the trolley is configured to utilize the rails of a building management unit (BMU) to manoeuvre about the roof of the building.

Numbered Paragraph 3. The system of Numbered Paragraph 2, wherein the trolley carries a pair of spaced rail engagement mechanisms configured to releasably engage parallel rails of the BMU.

Numbered Paragraph 4. The system of Numbered Paragraph 3, wherein at least one of the rail engagement mechanisms is slidably mounted to the trolley to allow selectively adjusting spacing of the pair of rail engagement mechanisms.

Numbered Paragraph 5. The system of Numbered Paragraph 3, wherein the trolley includes three of the rail engagement mechanisms arranged on a common plane at vertices of a notional triangle.

Numbered Paragraph 6. The system of Numbered Paragraph 3, wherein each rail engagement mechanism includes a bogie frame carrying a plurality of wheels.

Numbered Paragraph 7. The system of Numbered Paragraph 6, wherein the bogie frame is configured to arrange a pair of wheels at one side of a rail, and at least one other wheel on an opposed side of the rail.

Numbered Paragraph 8. The system of Numbered Paragraph 3, wherein each rail engagement mechanism is pivotably mounted to the trolley to allow motion of the trolley along curved rails.

Numbered Paragraph 9. The system of Numbered Paragraph 1, wherein the trolley includes a plurality of wheels to allow wheeling about the roof of the building.

Numbered Paragraph 10. The system of Numbered Paragraph 9, wherein the trolley includes a plurality of castor wheels arranged on a common plane at vertices of a notional triangle.

Numbered Paragraph 11. The system of Numbered Paragraph 1, wherein the crane member is rotatably mounted to the trolley.

Numbered Paragraph 12. The system of Numbered Paragraph 11, wherein the crane member is rotatable about an operatively horizontal axis to allow tilting the distal end relative to the trolley.

Numbered Paragraph 13. The system of Numbered Paragraph 11, wherein the crane member is rotatably mounted to the trolley about an operatively vertical axis to allow lateral rotation of the distal end relative to the trolley.

Numbered Paragraph 14. The system of Numbered Paragraph 1, wherein the crane member includes a jib defining the distal end, a counterjib extending in an opposite direction to the jib, a jib strut extending substantially perpendicular to the jib, and the system further includes one or more tension members connected between the jib, the jib strut, and the counterjib.

Numbered Paragraph 15. The system of Numbered Paragraph 14, including a further tension member connected between the counterjib and the trolley.

Numbered Paragraph 16. The system of Numbered Paragraph 14, including one or more counterweights mounted to the counterjib.

Numbered Paragraph 17. The system of Numbered Paragraph 1, including a counterweight system associated with the trolley.

Numbered Paragraph 18. The system of Numbered Paragraph 1, wherein the crane member is modular to allow being stowed in a compact volume.

Numbered Paragraph 19. The system of Numbered Paragraph 1, wherein the crane member is formed from a plurality of releasably connected struts.

Numbered Paragraph 20. The system of Numbered Paragraph 19, wherein the jib is formed from a plurality of releasably connected tubular members.

Numbered Paragraph 21. A manually portable modular kit for facilitating façade inspection of a building, the kit including:
a trolley comprising a base module configured for movement across a roof of a building, and a releasably mountable jib module;
an imaging module associated with one or more propulsion mechanisms operable to stabilise the module relative to the building;
a cable connectable to the imaging module; and
a winch module releasably mountable on the trolley and having a spool, the winch module engageable with the cable and operable to wind the cable around the spool.

Numbered Paragraph 22. The kit of Numbered Paragraph 21, further including a plurality of motion control modules releasably mountable to the base module, each motion control module operable to facilitate movement of the trolley across the roof.

Numbered Paragraph 23. The kit of Numbered Paragraph 22, wherein each motion control module is configured for releasably mounting to a rail of a BMU.

Numbered Paragraph 24. The kit of Numbered Paragraph 23, further including a drive mechanism configured to be associated with one of the motion control modules and operable to drive the motion control module along the rail.

Numbered Paragraph 25. The kit of Numbered Paragraph 24, further including a controller module communicatively coupled with the winch module, the imaging module, and the drive mechanism and operable to control operation of any of the winch module, the imaging module, and the drive mechanism.

Numbered Paragraph 26. The kit of Numbered Paragraph 21, further including a pivot module arrangeable between the base module and the jib module to allow relative rotation of the base module and the jib module about at least one axis.

Numbered Paragraph 27. The kit of Numbered Paragraph 21, wherein at least one of the base module and the jib module are formed from a plurality of interconnectable elongate members.

Numbered Paragraph 28. A method for inspecting a façade of a building using the kit of a Numbered Paragraph 21, the method including:
mounting the jib module to the base module;
mounting the winch module to the trolley;
securing the cable between the imaging module and the winch module;
positioning the trolley on a roof of the building so that an end of the jib module is spaced outwardly from the building to suspend the imaging module in an elevated position adjacent the building; and
operating the winch module to raise or lower the imaging module, and/or moving the trolley along one or more paths about a peripheral region of the roof, concurrent with operating the imaging module to capture images of the façade.

Numbered Paragraph 29. The method of Numbered Paragraph 28, including successively repeating the steps of moving the trolley along the one or more paths, and operating the winch mechanism, to cause the imaging module to successively traverse laterally, and vertically, across the façade.

Numbered Paragraph 30. A functional platform for suspending from a line to be at an elevated position relative to a building, the functional platform including:
a body including a connector arranged at an operatively top end of the body and configured to couple to the line;
a utility module arranged at one side of the body; and
a drive mechanism operable to drive the platform in at least one direction to allow driving the utility module relative to the building.

Numbered Paragraph 31. The functional platform of Numbered Paragraph 30, wherein the platform includes a plurality of propulsion mechanisms, and wherein each mechanism includes a powered rotor operable to generate thrust.

Numbered Paragraph 32. The functional platform of Numbered Paragraph 31 wherein each propulsion mechanism is arranged in a conduit defined by the body to provide ducted thrust.

Numbered Paragraph 33. The functional platform of Numbered Paragraph 30, wherein the utility module includes at least one of a tool and a sensor.

Numbered Paragraph 34. The functional platform of Numbered Paragraph 30, wherein the utility module includes an imaging system.

1-48. (canceled)

49. A system for positioning a functional platform including an imaging system at an elevated position relative to external walls of a building to facilitate façade inspection, the system including:
a manually portable trolley configured to be movable across a roof of the building, and carrying a crane member having a distal end, the trolley and crane member configured to be disassembled;
a winch mechanism mounted to the trolley; and
a suspension line extending between the functional platform and the winch mechanism,
whereby, in use, the trolley is positioned on the roof of the building so that the distal end is arranged beyond a leading edge of the building to suspend the functional platform at the elevated position, and is movable across the roof, and the functional platform is raised and lowered via the suspension line to allow access across the building facade.

50. The system of claim 49, wherein the trolley is configured to utilize the rails of a building management unit (BMU) to manoeuvre about the roof of the building.

51. The system of claim 50, wherein the trolley carries a pair of spaced rail engagement mechanisms configured to releasably engage parallel rails of the BMU.

52. The system of claim 51, wherein at least one of the rail engagement mechanisms is slidably mounted to the trolley to allow selectively adjusting spacing of the pair of rail engagement mechanisms.

53. The system of claim 51, wherein the trolley includes three of the rail engagement mechanisms arranged on a common plane at vertices of a notional triangle.

54. The system of claim 51, wherein each rail engagement mechanism includes a bogie frame carrying a plurality of wheels.

55. The system of claim 54, wherein the bogie frame is configured to arrange a pair of wheels at one side of a rail, and at least one other wheel on an opposed side of the rail.

56. The system of claim 51, wherein each rail engagement mechanism is pivotably mounted to the trolley to allow motion of the trolley along curved rails.

57. The system of claim 49, wherein the trolley includes a plurality of wheels to allow wheeling about the roof of the building.

58. The system of claim 57, wherein the trolley includes a plurality of castor wheels arranged on a common plane at vertices of a notional triangle.

59. The system of claim 49, wherein the crane member is rotatably mounted to the trolley.

60. The system of claim 59, wherein the crane member is rotatable about an operatively horizontal axis to allow tilting the distal end relative to the trolley.

61. The system of claim 59, wherein the crane member is rotatably mounted to the trolley about an operatively vertical axis to allow lateral rotation of the distal end relative to the trolley.

62. The system of claim 49, wherein the crane member includes a jib defining the distal end, a counterjib extending in an opposite direction to the jib, a jib strut extending substantially perpendicular to the jib, and the system further includes one or more tension members connected between the jib, the jib strut, and the counterjib.

63. The system of claim 62, including a further tension member connected between the counterjib and the trolley.

64. The system of claim 62, including one or more counterweights mounted to the counterjib.

65. The system of claim 49, including a counterweight system associated with the trolley.

66. The system of claim 49, wherein the crane member is modular to allow being stowed in a compact volume.

67. The system of claim 49, wherein the crane member is formed from a plurality of releasably connected struts.

68. The system of claim 67, wherein the jib is formed from a plurality of releasably connected tubular members.

69. A manually portable modular kit for facilitating façade inspection of a building, the kit including:
a trolley comprising a base module configured for movement across a roof of a building, and a releasably mountable jib module;
an imaging module associated with one or more propulsion mechanisms operable to stabilise the module relative to the building;
a cable connectable to the imaging module; and
a winch module releasably mountable on the trolley and having a spool, the winch module engageable with the cable and operable to wind the cable around the spool.

70. The kit of claim 69, further including a plurality of motion control modules releasably mountable to the base module, each motion control module operable to facilitate movement of the trolley across the roof.

71. The kit of claim 70, wherein each motion control module is configured for releasably mounting to a rail of a BMU.

72. The kit of claim 71, further including a drive mechanism configured to be associated with one of the motion control modules and operable to drive the motion control module along the rail.

73. The kit of claim 72, further including a controller module communicatively coupled with the winch module, the imaging module, and the drive mechanism and operable to control operation of any of the winch module, the imaging module, and the drive mechanism.

74. The kit of claim 69, further including a pivot module arrangeable between the base module and the jib module to allow relative rotation of the base module and the jib module about at least one axis.

75. The kit of claim 69, wherein at least one of the base module and the jib module are formed from a plurality of interconnectable elongate members.

76. A method for inspecting a façade of a building using the kit of a claim 69, the method including:
mounting the jib module to the base module;
mounting the winch module to the trolley;
securing the cable between the imaging module and the winch module;
positioning the trolley on a roof of the building so that an end of the jib module is spaced outwardly from the building to suspend the imaging module in an elevated position adjacent the building; and
operating the winch module to raise or lower the imaging module, and/or moving the trolley along one or more paths about a peripheral region of the roof, concurrent with operating the imaging module to capture images of the façade.

77. The method of claim 76, including successively repeating the steps of moving the trolley along the one or more paths, and operating the winch mechanism, to cause the imaging module to successively traverse laterally, and vertically, across the façade.

78. A functional platform for suspending from a line to be at an elevated position relative to a building, the functional platform including:
a body including a connector arranged at an operatively top end of the body and configured to couple to the line;
a utility module arranged at one side of the body; and
a drive mechanism operable to drive the platform in at least one direction to allow driving the utility module relative to the building.

79. The functional platform of claim 78, wherein the platform includes a plurality of propulsion mechanisms, and wherein each mechanism includes a powered rotor operable to generate thrust.

80. The functional platform of claim 79 wherein each propulsion mechanism is arranged in a conduit defined by the body to provide ducted thrust.

81. The functional platform of claim 78, wherein the utility module includes at least one of a tool and a sensor.

82. The functional platform of claim 78, wherein the utility module includes an imaging system.
